(19) United States
(12) Patent Application Publication
(10) Pub. No.: US 2022/0334409 A1
(43) Pub. Date: Oct. 20, 2022

(54) A CONTACT LENS SOLUTION FOR MYOPIA MANAGEMENT

(71) Applicant: NTHALMIC HOLDING PTY LTD, Sydney, New South Wales (AU)

(72) Inventors: Ravi Chandra Bakaraju, Sydney, New South Wales (AU); Klaus Ehrmann, Sydney, New South Wales (AU); Fabian Conrad, Sydney, New South Wales (AU)

(21) Appl. No.: 17/641,086

(22) PCT Filed: Sep. 23, 2020
(86) PCT No.: PCT/AU2020/051004

§ 371 Date: Mar. 7, 2022

(30) Foreign Application Priority Data
Sep. 25, 2019 (AU) 2019903580
Feb. 14, 2020 (AU) 2020900412

(51) Int. Cl. G02C 7/04

(52) U.S. Cl. CPC G02C 7/04; G02C 2202/24

(57) ABSTRACT

The present disclosure relates to contact lenses for use with eyes experiencing eye-length related disorders, like myopia. This invention relates to a contact lens for managing myopia of an eye; wherein the contact lens is configured with an optical zone defined substantially centred about its optical axis to provide substantially toric or astigmatic cues for the eye; and a non-optical peripheral carrier zone about the optical zone configured with a thickness profile that is substantially rotationally symmetric to further to provide temporally and spatially varying stop signals to decelerate, ameliorate, control, inhibit, or reduce the rate of myopia progression over time.

### CROSS-REFERENCE

This application claims priority to Australian Provisional Application Serial No. 2019/903580 filed on Sep. 25, 2019, entitled “A contact lens for myopia” and another Australian Provisional Application Serial No. 2020/900412 filed on Feb. 14, 2020, entitled “Contact lens”, both of which are herein incorporated by reference in their entirety.

### FIELD OF THE INVENTION

The present disclosure relates to contact lenses for use with eyes experiencing eye-length related disorders, like myopia. This invention relates to a contact lens for managing myopia of an eye; wherein the contact lens is configured with an optical zone defined substantially about its optical axis to provide substantially toric or astigmatic directional cues for the eye; and a non-optical peripheral carrier zone about the optical zone configured with a thickness profile that is substantially rotationally symmetric, to further to provide temporally and spatially varying directional cues or optical stop signals to decelerate, ameliorate, control, inhibit, or reduce the rate of myopia progression over time.

### BACKGROUND

Human eyes are hyperopic at birth, where the length of the eyeball is too short for the total optical power of the eye. As the person ages from childhood to adulthood, the eyeball continues to grow until the eye's refractive state stabilises. The growth of the eye is understood to be controlled by a feedback mechanism and regulated predominantly by the visual experience, to match the eye's optics with the eye length and maintain homeostasis. This process is referred to as emmetropisation.

The signals guiding the emmetropisation process are initiated by the modulation of light energy received at the retina. The retinal image characteristics are monitored by a biological process that modulates the signal to start or stop, accelerate, or slow eye growth. This process coordinates between the optics and the eyeball length to achieve or maintain emmetropia. Derailing from this emmetropisation process results in refractive disorders like myopia. It is hypothesised that increased retinal activity inhibits eye growth and vice versa.

The rate of incidence of myopia is increasing at alarming rates in many regions of the world, particularly in the East Asia region. In myopic individuals, the axial length of the eye is mismatched to the overall power of the eye, leading to distant objects being focused in front of the retina.

A simple pair of negative single vision lenses can correct myopia. While such devices can optically correct the refractive error associated with eye-length, they do not address the underlying cause of the excessive eye growth in myopia progression.

Excessive eye-length in high degrees of myopia is associated with significant vision-threatening conditions like cataract, glaucoma, myopic maculopathy, and retinal detachment. Thus, there remains a need for specific optical devices for such individuals, that not only correct the underlying refractive error but also prevent excessive eye lengthening or progression of myopia, whereby the treatment effect remains substantially consistent over time.

### Definitions

Terms, as used herein, are generally used by a person skilled in the art, unless otherwise defined in the following.

The term “myopic eye” means an eye that is either already experiencing myopia, is in the stage of pre-myopia, is at risk of becoming myopic, is diagnosed to have a refractive condition that is progressing towards myopia and has astigmatism of less than 1 DC.

The term “progressing myopic eye” means an eye with established myopia that is diagnosed to be progressing, as gauged by either the change in refractive error of at least −0.25 D/year or the change in axial length of at least 0.1 mm/year.

The term “an eye at risk of becoming myopic” means an eye, which could be emmetropic or is low hyperopic at the time but has been identified to have an increased risk of becoming myopic based on genetic factors (e.g. both parents are myopic) and/or age (e.g. being low hyperopic at a young age) and/or environmental factors (e.g. time spent outdoors) and/or behavioural factors (e.g. time spent performing near tasks).

The term “optical stop signal” or “stop signal” means an optical signal or directional cue that may facilitate slowing, reversing, arresting, retarding, inhibiting, or controlling the growth of an eye and/or refractive condition of the eye.

The term “spatially varying optical stop signal” means an optical signal or directional cue, provided at the retina, which changes spatially across the retina of the eye.

The term “temporally varying optical stop signal” means an optical signal or directional cue, provided at the retina, which changes with time.

The term “spatially and temporally varying optical stop signal” means an optical signal or directional cue, provided at the retina, which changes with time and spatially across the retina of the eye.

The term “contact lens” means a finished contact lens to be fit on the cornea of a wearer to affect the optical performance of the eye, usually packaged in a vial, blister pack or similar.

The term “optical zone” or “optic zone” means the region on the contact lens which has the prescribed optical effect. The optical zone may be further distinguished to have regions of varying power distribution about the optical centre or the optical axis.

The optical zone may be further distinguished by front and back optic zone. The front and back optic zones mean anterior and posterior surface areas of a contact lens which contribute to the prescribed optical effect, respectively. An optical zone of the contact lens may be circular or elliptical or of another irregular shape. The optic zones of contact lenses with only sphere powers are generally circular. However, the introduction of toricity may lead to an elliptical optical zone in certain embodiments.

The term “optical centre” or “optic centre” means the geometric centre of the optical zone of the contact lens. The terms geometrical and geometric are essentially the same.

The term “optical axis” means the line passing through the optical centre and substantially perpendicular to the plane containing the edge of the contact lens.

The term “blend zone” is the zone that connects or lies between the optical zone and the peripheral carrier zone of the contact lens. The term “blending zone” is synonymous with “blend zone” in certain embodiments and may be on the front or the back surface or both surfaces of the contact lens. The blend zone may be polished, smoothed junction(s) between the two different adjacent surface curvatures. The thickness of the blending zone may also be referred to as junction thickness.

The term “through-focus” means a region that is substantially anterior-posterior to the retina. In other words, a region approximately just in front of the retina and/or approximately just behind the retina.

The term “carrier zone” is a non-optical zone that connects or lies between the blend zone and the edge of the contact lens. The term “peripheral zone” or “peripheral carrier zone” is synonymous with “carrier zone” with no prescribed optic effect in certain embodiments.

The term or phrase “spherical optical zone” may mean that the optical zone has a uniform power distribution without substantial amounts of primary spherical aberration.

The term or phrase “non-spherical optical zone” may mean that the optical zone does not have a uniform optical power distribution. The non-spherical optical zone may be further classified into lower-order aberrations like astigmatism or toricity in certain embodiments. The terms or phrases “astigmatic optical zone” or “toric optical zone” may mean that the optical zone has a sphero-cylindrical power distribution.

The term “ballast” means a rotationally asymmetrical distribution of thickness profile within the carrier zone to affect the rotational orientation of a contact lens when placed on an eye.

The term “prism ballast” means a vertical prism used to create a wedge design that will help stabilise the rotation and orientation of a toric contact lens on the eye.

The term “slab-off” means purposeful thinning of the contact lens towards the edge of the inferior and superior periphery of the contact lens in one or more discrete areas to achieve desired contact lens rotational stabilisation.

The term “truncation” refers to an inferior edge of a contact lens that is designed with a nearly straight line for control over rotational stabilisation of a contact lens.

The terms “negative”, “plano” or “positive” carrier means the contact lens having an edge thickness, as measured approximately 0.1 mm distance from the lens diameter, that is greater than the junction thickness, edge thickness equal to the junction thickness and edge thickness less than the junction thickness, respectively.

The term “model eye” may mean a schematic, raytracing, or a physical model eye.

The terms “Diopter”, “Dioptre” or “D” as used herein is the unit measure of dioptric power, defined as the reciprocal of the focal distance of a lens or an optical system, in meters, along an optical axis. Usually, the letter “D” signifies spherical dioptric power, and the letter “DC” signifies cylindrical dioptric power.

The terms “conoid of Sturm” or “interval of Sturm” means the resultant substantially on-axis through-focus image on or about the retina formed due to astigmatism, toricity, or asymmetric power profile configured substantially centred about the optical centre or the optical axis, represented with the elliptical blur patterns comprising the tangential and sagittal planes including a circle of least confusion.

The term “power profile” means the one-dimensional power distribution of localised optical power across the optical zone, either as a function of radial distance at a given azimuthal angle with the optical centre as a reference or as a function of an azimuthal angle measured at a given radial distance.

The term “power map” means the two-dimensional power distribution across the optical zone in cartesian or polar coordinates. The term “radial” means in the direction radiating out from the optical centre to edge of the optic zone, defined along an azimuthal angle. The term “azimuthal” means in the direction along the defined circumference, at a radial distance, about the defined optical axis or optical centre.

The term “back vertex power” means the reciprocal of back vertex focal length over the entire or a specified region over the optical zone, expressed in Dioptres (D). The term “meridian of the optic zone” means any meridian about the optic centre in any azimuthal angle.

The terms “SPH” or “Spherical” power means substantially uniform power between all meridians of the optic zone. The terms “CYL”, “Cylinder” power means the difference in back vertex powers between the two principal meridians within the optical zone.

The term “asymmetric optic zone” means variation of the localised power along the azimuthal direction about the optic centre while maintaining mirror symmetry along an arbitrarily chosen meridian.

The terms “meridional correction” or “meridional correction of the eye” means a partial correction for the eye in at least one meridian on the retina of the eye. The terms “meridional astigmatism” or “meridional astigmatism for the eye” means the introduced or induced astigmatism in at least one meridian of the eye.

The term “specific fit” means that the non-optical peripheral carrier zone is configured with a thickness profile that is substantially rotationally symmetric about the optical centre to facilitate substantially free rotation of the contact lens over time. The specific fit referred in this invention means that the non-optical peripheral carrier zone is configured with a thickness profile that is substantially free of ballast, or prism, or any truncation.

The term “sub-foveal region” means the region immediately adjacent to the foveal pit of the retina of an eye. The term “parafoveal region” means the region immediately adjacent to the foveal region of the retina of an eye.

The term “sub-macular region” means the region within the macular region of the retina of an eye. The term “paramacular region” means the region immediately adjacent to the macular region of the retina of an eye.

### SUMMARY

Certain disclosed embodiments include contact lenses for altering the wavefront properties of incoming light entering a human eye. Certain disclosed embodiments are directed to the configuration of contact lenses for correcting, managing, and treating refractive errors.

One of the embodiments of the proposed invention is aimed to both correct the myopic refractive error and simultaneously provide an optical stop signal that discourages further eye growth or progression of myopia. The proposed optical device provides a substantially continuously changing astigmatic blur (i.e. optical stop signal) imposed on the central and peripheral retinal region.

This disclosure includes an astigmatic, or a toric, contact lens that is purposefully designed without a stabilisation carrier zone to offer a temporally and spatially varying astigmatic blur stop signal on the central and peripheral retina.

One other proposed embodiment is an asymmetric contact lens that is used for correcting the myopic refractive error and also provide an optical stop signal that inhibits further eye growth or decelerates the rate of eye growth. Another feature of the proposed embodiment may include a blending between the rotationally asymmetric optical zone and the symmetric carrier zone of the proposed contact lens. This blending zone may be circular or elliptical.

Certain embodiments configured with a toric correction substantially centred about the optical centre or the optical axis may overcome the limitations of the prior art by providing a temporally and spatially varying stop signal. Thus, allowing for minimisation of saturation of treatment effect on myopia progression. In another embodiment, the present invention is directed to a contact lens for at least one of slowing, retarding, or preventing myopia progression.

Another embodiment of the present disclosure is a contact lens comprising a front surface, a back surface, an optical centre, an optic zone about the optical centre, a toric or astigmatic power profile defined substantially about the optical centre, wherein the toric or astigmatic profile is configured to provide, at least in part, adequate foveal correction, and at least in part an optical stop signal to reduce the rate of myopia progression; the said contact lens is further configured with a rotationally symmetric peripheral carrier zone to provide a temporally and spatially variant optical stop signal; such that the treatment efficacy to reduce the progression of eye growth remains substantially consistent over time.

In accordance with one of the embodiments, the present disclosure is directed to a contact lens for a myopic eye. The contact lens comprising a front surface, a back surface, an optical axis, an optic zone about the optical axis, an asymmetric power profile about the optical axis, wherein the asymmetric profile is configured to provide, at least in part, adequate meridional correction, and at least in part an optical stop signal to reduce the rate of myopia progression; the said contact lens is further configured with a rotationally symmetric peripheral carrier zone to provide a temporally and spatially variant optical stop signal; such that the treatment efficacy to reduce the progression of eye growth remains substantially consistent over time.

The embodiments presented in this disclosure are directed to the ongoing need for enhanced optical designs and contact lenses that may inhibit the progression of myopia while providing reasonable and adequate vision performance to the wearer for a range of activities that the wearer may undertake as a part of their daily routine. Various aspects of the embodiments of the present invention disclosure address such needs of a wearer.

### BRIEF DESCRIPTION OF THE FIGURES

FIG. 1 illustrates the frontal view and a cross-sectional view of a contact lens embodiment. The frontal view further illustrates the optic centre, optic zone, blend zone and the carrier zone, according to certain embodiments.

FIG. 2 illustrates the frontal view and a cross-sectional view of another contact lens embodiment. The sphero-cylindrical correction in the optic zone of an embodiment may lead to an elliptical optical zone. The frontal view further illustrates that the radial cross-sections of the carrier zone of an embodiment have the substantially similar thickness, according to certain embodiments.

FIG. 3 illustrates the frontal view of, yet another contact lens embodiment disclosed herein. The frontal view further illustrates a potential free rotation of the contact lens substantially around the optical centre due to the configuration of the carrier zone design. The substantially free rotation of the contact lens is facilitated by its carrier zone designed with substantially similar radial thickness profiles, according to certain embodiments

FIG. 4 illustrates a schematic diagram of an on-axis, geometric spot analysis at the retinal plane, when the incoming light, with a visible wavelength (for example, 589 nm) and a vergence of 0 D, is incident on an uncorrected −3 D myopic model eye.

FIG. 5 illustrates a schematic diagram of an on-axis, geometric spot analysis at the retinal plane, when the incoming light, with a visible wavelength (for example, 589 nm) and a vergence of 0 D, is incident on a −3 D myopic model eye corrected with a single vision contact lens of the prior art.

FIG. 6 illustrates a schematic diagram of an on-axis, through-focus geometric spot analysis at the retinal plane, when the incoming light, with a visible wavelength (589 nm) and a vergence of 0 D, is incident on a −3 D myopic model eye corrected with one of the contact lens embodiments disclosed herein.

FIG. 7 illustrates the schematic diagram of a zoomed-in section of only the optical zone of one of the contact lens embodiments with a toric or sphero-cylindrical prescription disclosed herein. The power profile distribution within the optical zone of the present embodiment is configured using the radial and azimuthal power distribution functions, as disclosed herein.

FIG. 8 shows the power map distribution within the optic zone of an exemplary embodiment of the current disclosure. FIG. 9 shows the radial thickness distribution of the whole contact lens of an exemplary embodiment of the current disclosure.

FIG. 10 illustrates the temporally and spatially varying signal due to contact lens rotation depicted as on-axis point spread function at the retinal plane, when the incoming light with a visible wavelength (for example 589 nm) and a vergence of 0 D, is incident on a −3 D myopic model eye corrected with the contact lens embodiment described in FIGS. 8 and 9.

FIG. 11 illustrates the temporally and spatially varying signal due to contact lens rotation depicted as wide-view through-focus geometric spot analysis, when the incoming light with a visible wavelength (for example 589 nm) and a vergence of 0 D, is incident on a −3 D myopic model eye corrected with the contact lens embodiment described in FIGS. 8 and 9.

FIG. 12 illustrates the retinal signal depicted due to contact lens rotation as on-axis, through-focus, modulus of the optical transfer function for the principal and perpendicular meridians of the temporally and spatially varying point spread functions of FIG. 10, which was computed when the incoming light with a visible wavelength (for example 589 nm) and a vergence of 0 D, is incident on a −3 D myopic model eye corrected with the contact lens embodiment described in FIGS. 8 and 9.

FIG. 13 shows the power map distribution within the optic zone of another exemplary embodiment of the current disclosure.

FIG. 14 shows the radial thickness distribution of the whole contact lens of the prior art.

FIG. 15 shows the radial thickness distribution of the whole contact lens of an exemplary embodiment of the current disclosure shown in FIG. 13.

FIG. 16 illustrates the temporally and spatially varying signal due to contact lens rotation depicted as on-axis point spread function at the retinal plane, when the incoming light with a visible wavelength (589 nm) and a vergence of 0 D, is incident on a −3 D myopic model eye corrected with the contact lens embodiment described in FIGS. 13 and 15.

FIG. 17 illustrates the temporally and spatially varying signal due to contact lens rotation depicted as wide-view through-focus geometric spot analysis, when the incoming light with a visible wavelength (589 nm) and a vergence of 0 D, is incident on a −3 D myopic model eye corrected with the contact lens embodiment described in FIGS. 13 and 15.

FIG. 18 illustrates the retinal signal depicted due to contact lens rotation as on-axis, through-focus, modulus of the optical transfer function for the principal and perpendicular meridians of the temporally and spatially varying point spread functions of FIG. 16, which was computed when the incoming light with a visible wavelength (for example 589 nm) and a vergence of 0 D, is incident on a −3 D myopic model eye corrected with the contact lens embodiment described in FIGS. 13 and 15.

FIG. 19 shows the power map distribution within the optic zone of another exemplary embodiment of the current disclosure.

FIG. 20 shows the radial thickness distribution of the whole contact lens of another exemplary embodiment of the current disclosure.

FIG. 21 illustrates the temporally and spatially varying signal depicted due to contact lens rotation as on-axis point spread function at the retinal plane, when the incoming light with a visible wavelength (589 nm) and a vergence of 0 D, is incident on a −3 D myopic model eye corrected with the contact lens embodiment described in FIGS. 19 and 20.

FIG. 22 illustrates the temporally and spatially varying signal depicted due to contact lens rotation as wide-view through-focus geometric spot analysis, when the incoming light with a visible wavelength (589 nm) and a vergence of 0 D, is incident on a −3 D myopic model eye corrected with the contact lens embodiment described in FIGS. 19 and 20.

FIG. 23 illustrates the retinal signal depicted due to contact lens rotation as on-axis, through-focus, modulus of the optical transfer function for the principal and perpendicular meridians of the temporally and spatially varying point spread functions of FIG. 21, which was computed when the incoming light with a visible wavelength (for example 589 nm) and a vergence of 0 D, is incident on a −3 D myopic model eye corrected with the contact lens embodiment described in FIGS. 19 and 20.

FIG. 24 shows the power map distribution within the optic zone of another exemplary embodiment of the current disclosure.

FIG. 25 shows the radial thickness distribution of the whole contact lens of another exemplary embodiment of the current disclosure.

FIG. 26 illustrates the temporally and spatially varying signal depicted due to contact lens rotation as on-axis point spread function at the retinal plane, when the incoming light with a visible wavelength (589 nm) and a vergence of 0 D, is incident on a −3 D myopic model eye corrected with the contact lens embodiment described in FIGS. 24 and 25.

FIG. 27 illustrates the temporally and spatially varying signal depicted due to contact lens rotation as wide-view through-focus geometric spot analysis, when the incoming light with a visible wavelength (589 nm) and a vergence of 0 D, is incident on a −3 D myopic model eye corrected with the contact lens embodiment described in FIGS. 24 and 25.

FIG. 28 illustrates the retinal signal depicted due to contact lens rotation as on-axis, through-focus, modulus of the optical transfer function for the principal and perpendicular meridians of the temporally and spatially varying point spread functions of FIG. 26, which was computed when the incoming light with a visible wavelength (for example 589 nm) and a vergence of 0 D, is incident on a −3 D myopic model eye corrected with the contact lens embodiment described in FIGS. 24 and 25.

FIG. 29 illustrates the temporally and spatially varying signal depicted due to contact lens decentration as on-axis point spread function at the retinal plane, when the incoming light with a visible wavelength (589 nm) and a vergence of 0 D, is incident on a −3 D myopic model eye corrected with the contact lens embodiment described in FIGS. 13 and 15.

FIG. 30 illustrates the temporally and spatially varying signal depicted due to contact lens decentration as wide-view through-focus geometric spot analysis, when the incoming light with a visible wavelength (589 nm) and a vergence of 0 D, is incident on a −3 D myopic model eye corrected with the contact lens embodiment described in FIGS. 13 and 15.

FIG. 31 illustrates the retinal signal depicted due to contact lens decentration as on-axis, through-focus, modulus of the optical transfer function for the principal and perpendicular meridians of the temporally and spatially varying point spread functions of FIG. 29, which was computed when the incoming light with a visible wavelength (for example 589 nm) and a vergence of 0 D, is incident on a −3 D myopic model eye corrected with the contact lens embodiment described in FIGS. 13 and 15.

FIG. 32a illustrates the measured thickness profile of prototype contact lenses (Lens #1) which is a variant of a contact lens embodiment described in FIG. 19. FIG. 32b illustrates the measured thickness profile of prototype contact lenses (Lens #2) which is a variant of a contact lens embodiment described in FIG. 19.

FIG. 33a illustrates the measured relative meridional powers of the optic zones of the prototype contact lens (Lens #1) which is a variant of a contact lens embodiment described in FIG. 19. FIG. 33b illustrates the measured relative meridional powers of the optic zones of the prototype contact lens (Lens #2) which is a variant of a contact lens embodiment described in FIG. 19.

FIG. 34a illustrates the measured thickness profiles of the two principal meridians (vertical and horizontal) of a commercially available toric contact lens (Control #1). FIG. 34b illustrates the measured thickness profiles of the two principal meridians (vertical and horizontal) of a commercially available toric contact lens (Control #2).

FIG. 35 shows a picture of a device used for the measurement of contact lens rotation over time.

FIG. 36 shows the frontal view of a contact lens embodiment disclosed herein. The frontal view further illustrates a method, i.e. two markings on a contact lens, which were used to measure the azimuthal location, amount of rotation or the number of revolutions about the optical axis, of the two prototype contact lenses (Lens #1 and Lens #2) over time.

FIG. 37a shows the measured azimuthal position of one prototype contact lens (Lens #1) over time, i.e. approximately 30 minutes of lens wear.

FIG. 37b shows the measured azimuthal position of one commercially available toric contact lens (Control #1) over time, i.e. approximately 30 minutes of lens wear.

### DETAILED DESCRIPTION

In this section, the present disclosure is described in detail with reference to one or more embodiments, some are illustrated and supported by accompanying figures. The examples and embodiments are provided by way of explanation and are not to be construed as limiting to the scope of the disclosure.

The following description is provided in relation to several embodiments that may share common characteristics and features of the disclosure. It is to be understood that one or more features of one embodiment may be combined with one or more features of any other embodiments which may constitute additional embodiments.

The functional and structural information disclosed herein is not to be interpreted as limiting in any way and should be construed merely as a representative basis for teaching a person skilled in the art to employ the disclosed embodiments and variations of those embodiments in various ways.

The sub-titles and relevant subject headings used in the detailed description section have been included only for the ease of reference of the reader and in no way should be used to limit the subject matter found throughout the invention or the claims of the disclosure. The sub-titles and relevant subject headings should not be used in construing the scope of the claims or the claim limitations.

Risk of developing myopia or progressive myopia may be based on one or more of the following factors: genetics, ethnicity, lifestyle, environmental, excessive near work, etc. Certain embodiments of the present disclosure are directed towards a person at risk of developing myopia or progressive myopia.

To date, numerous contact lens optical designs have been proposed to control the rate of eye growth, i.e. myopia progression. Some contact lens design options with characteristics for retarding the rate of myopia progression include designs with some degree of relative positive power related to the prescription power of the lens, usually distributed rotationally symmetric around the optical axis of the contact lens.

Some problems with prior optical designs that are based on simultaneous images are that they compromise the quality of the vision at various other distances by introducing significant visual disturbances. This side effect is primarily attributed to significant levels of simultaneous defocus, use of significant amounts of spherical aberration, or drastic change in power within the optic zone.

Given the influence of compliance of contact lens wear on the efficacy of such lenses, significant reduction of visual performance may promote poor compliance thus resulting in poorer efficacy.

A simple linear model of emmetropisation suggests that the magnitude of a stop-signal accumulates over time. In other words, the accumulated stop-signal depends on the total magnitude of exposure and not its temporal distribution. However, the inventors have observed from reports of clinical trials of various optical designs that a disproportionally larger percentage of the achieved efficacy or the slowing effect on the rate of progression occurs in the first 6 to 12-months.

After the initial burst of treatment, the efficacy is observed to wane over time. So, in light of the clinical observations, a more faithful model of emmetropisation to line up with the clinical results suggests that there may be a delay before the stop-signal builds, then saturation occurs with time, and perhaps a decay in the effectiveness of the stop-signal.

There is a need in the art for a contact lens that minimises this saturation of the treatment effect by providing a temporally and spatially varying stop-signal to retard the rate of eye growth, for example, myopia progression, without the need of burdening the wearer to switch between contact lenses of differing optical designs during a given period.

Accordingly, there exists a need for optical designs with a mechanism to achieve substantially greater, and/or substantially consistent, efficacy over time in reducing and/or slowing myopia progression without significantly compromising visual performance. In one or more examples, the substantially consistent efficacy overtime may be considered to be at least 6, 12, 18, 24, 36, 48 or 60 months.

Embodiments of the present disclosure relate to an optical intervention that utilises the effects of purposefully configured astigmatic blur on the visual system to inhibit or decelerate the rate of myopia progression. More specifically, some embodiments relate to a toric contact lens that is purposefully designed without any or substantial stabilisation in the non-optical peripheral carrier zone and which has optical characteristics for decelerating the rate or halting the progressive myopic refractive error.

The optical characteristics may include, at least in part, the introduction of astigmatic blur at the retinal level of the wearer's eye in combination with a rotationally symmetric peripheral carrier zone serves as a temporally and spatially varying stop signal to the myopic eye or the eye that may be progressing towards myopia.

The present disclosure is also directed to devices, methods and/or systems of modifying the incoming light through contact lenses that utilise astigmatic cues to decelerate the rate of myopia progression.

In some embodiments, a contact lens device or method provides a stop-signal to retard the rate of eye growth or stop the eye growth, or the state of refractive error, of the wearer's eye based on an astigmatic blur signal. In some embodiments, the said contact lens device configured with a rotationally symmetric peripheral carrier zone provides a temporally and spatially varying stop-signal for increasing the effectivity of managing progressive myopia.

In some embodiments, the contact lens device or method is not solely based on either positive spherical aberration, or simultaneous defocus which suffers from the potential visual performance degradation for the wearer.

The following exemplary embodiment is directed to methods of modifying the incoming light through a contact lens that offers simultaneous astigmatic cues at the retinal plane of the corrected eye. This may be achieved by using a toric optical zone of a contact lens to provide at least in part meridional correction of myopia.

The use of a toric optical zone of a contact lens may be configured with properties designed to reduce the rate of myopia progression by introducing astigmatic directional cues at the retinal level. In certain embodiments, the use of astigmatic directional cues obtained with a toric contact lens may be configured to be spatially and temporally variant.

Certain other embodiments of the present disclosure relate to an optical intervention that utilises the effects of a purposefully configured asymmetric zone in a contact lens to provide a directional cue to the visual system to inhibit or decelerate the rate of myopia progression. More specifically, some embodiments relate to the said contact lens that is purposefully designed without any or substantial stabilisation in the non-optical peripheral carrier zone and which has optical characteristics for decelerating the rate or halting the progressive myopic refractive error.

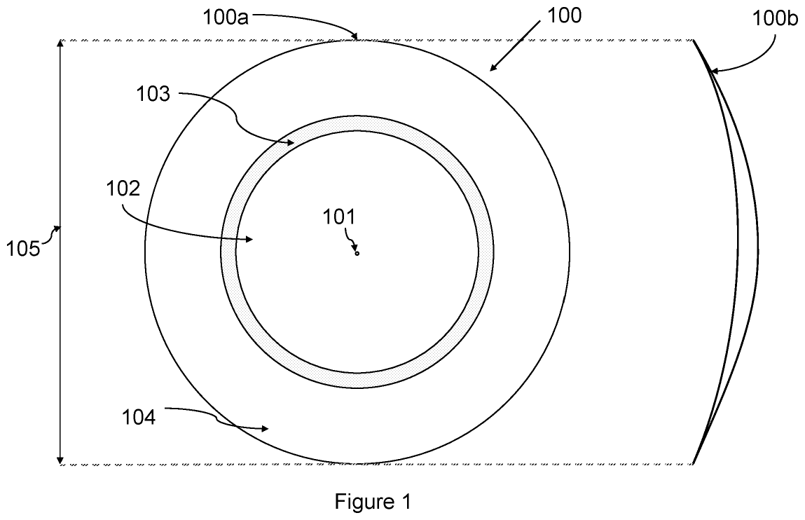

FIG. 1 shows the general structure of an exemplary contact lens embodiment (100) to which embodiments of the present invention may be applied, showing the lens in a frontal view (100a) and a cross-sectional (100b) view, not to scale. The frontal view of the exemplary contact lens embodiment (100) further illustrates a substrate that includes an optic centre (101), an optic zone (102), a blend zone (103), a non-optical peripheral carrier zone which is symmetrical (104) and a lens diameter (105). In this exemplary example, the lens diameter is approximately 14 mm, the optic zone is approximately 8 mm in diameter, the blend zone is approximately 0.25 mm wide and the carrier zone is approximately 2.75 mm wide.

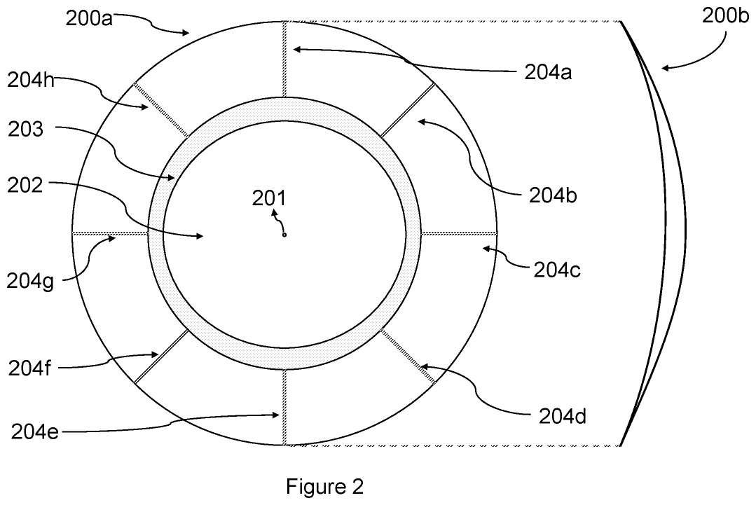

FIG. 2 shows the frontal view (200a) and a cross-sectional view (200b) of another exemplary contact lens embodiment, not to scale. The frontal view of the exemplary contact lens embodiment further illustrates a substrate that includes an optic centre (201), an optic zone (202), a blend zone (203) and a non-optical peripheral carrier zone (204). In this exemplary example, the lens diameter is approximately 14 mm in diameter, the optic-zone (202) is a sphero-cylindrical, or astigmatic, or toric, or asymmetric, the optic zone is elliptical and is approximately 8 mm in horizontal diameter and approximately 7.5 mm in vertical diameter, the blend zone is approximately 0.25 mm wide in the horizontal meridian and approximately 0.38 mm wide in the vertical meridian and the symmetrical peripheral carrier zone is approximately 2.75 mm wide. The radial cross-sections (204a to 204h) of the symmetrical peripheral carrier zone (204) have the same or substantially similar thickness profiles.

In certain embodiments, the differences in the thickness profiles along the different radial cross-sections (204a to 204h) may be configured to achieve the desired on-eye rotation about the optical centre of the lens. Preferred on-eye rotation can be achieved by keeping the peripheral thickness profile rotationally symmetric across all half meridians.

For example, the radial thickness profiles (for example 204a to 204h) may be configured such that the thickness profiles of any of the other radial cross-sections are substantially identical or within 4%, 6%, 8%, or 10% variance for any given distance from the centre of the lens.

In one example, the radial thickness profile 204a is within 5%, 8% or 10% variance of the radial thickness profile of 204e for any given distance from the centre of the lens. In another example, the radial thickness profile 204c is within 4%, 6% or 8% variance of the radial thickness profile of 204g for any given distance from the centre of the lens.

In yet another example, the radial thickness profiles (for example 204a to 204h) may be configured such that the thickness profiles of any of the cross-sections are within 4%, 6%, 8%, or 10% variation of the average of all radial cross sections for any given distance from the centre of the lens. To ascertain if the manufactured radial thickness profiles, for example, 204a to 204h, of the non-optical peripheral carrier zone conform to their nominal profiles, cross-sectional measurements of thickness along the azimuthal direction of the contact lens at a defined radial distance may be desired. In some other examples, the peak thickness measured in one radial cross-section may be compared with the peak thickness measured in another radial cross-section of the non-optical peripheral carrier zone.

In some embodiments, the difference in the peak thicknesses between one or more radial cross-sections may be no greater than 20 μm, 30 μm, 40 μm, 50 μm, or 60 μm. In some embodiments, the difference in the peak thicknesses between one or more perpendicular radial cross-sections may be no greater than 20 μm, 30 μm, 40 μm, 50 μm, or 60 μm.

In this exemplary example, the sphere power of the sphero-cylindrical or astigmatic or toric optic zone (202) of the contact lens embodiment (200) has a sphere power of −3 D to correct a −3 D myopic eye and a cylinder power of +1.25 DC to induce or introduce meridional astigmatism at the retina of the eye. In some other examples of the present disclosure, the sphere power of the contact lens to correct and manage myopic eyes may be between −0.5 D to −12 D and the desirable astigmatic or toric or cylinder power to induce or introduce the desired meridional astigmatism at the retina of the myopic eye may range between +0.75 DC to +2.5 DC.

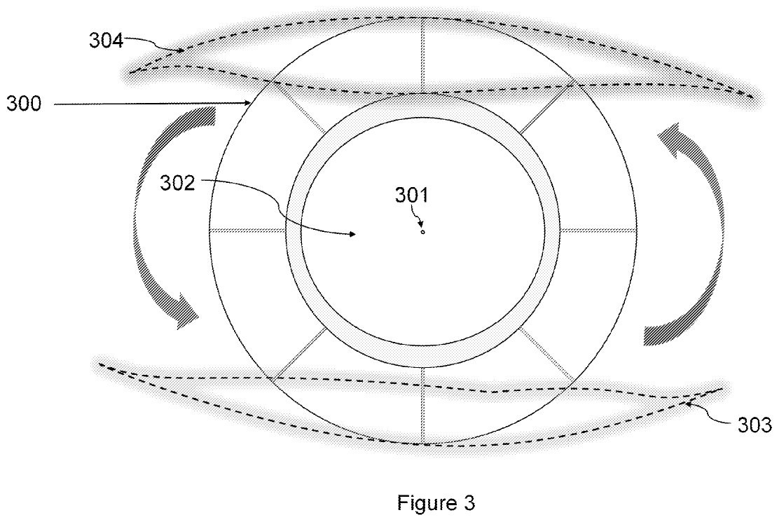

FIG. 3 shows the frontal view of the exemplary contact lens (300) embodiment illustrated in FIG. 2. This figure diagrammatically illustrates the effects of eyelids, lower (303) and upper (304) on the orientation of the contact lens embodiment (300), particularly the optical zone (302) defined about the optic centre (301).

Due to the natural blink facilitated by the combined action of the lower (303) and upper (304) eyelids, the contact lens (300) may rotate on or around about the optical centre (301). This may lead to the orientation and location of the astigmatic, or toric, or asymmetric, stimulus imposed by the optical zone (302), defined substantially centred about the optical centre or the optical axis, to vary with blink providing substantially free rotation and/or decentration, resulting in a temporally and spatially varying stimulus to reduce the rate of progression in a myopic wearer; wherein the effectiveness of managing myopia remains substantially consistent over time.

In some embodiments, for example, as described with reference to FIGS. 2 and 3, the contact lens is designed to exhibit substantially free rotation, at least under the influence of natural blinking action. For example, throughout a day of lens wear, preferably over 6 to 12 hours, the eyelid interaction will dispose the contact lens to be oriented in a large number of different orientations or configurations on the eye. Due to the astigmatic, or toric, or asymmetric, optics configured substantially about the optical centre of the said contact lens, the directional cues to control the rate of eye growth can be configured vary spatially and temporally.

In some embodiments, the surface parameters of the contact lens embodiment, for example, the back-surface radius and/or asphericity may be tailored to an individual eye such that a desired on-eye rotation of the contact lens may be achieved. For example, the said contact lens may be configured to at least 0.3 mm flatter than the radius of curvature of the flattest meridian of the cornea of the eye to increase the occurrences of on-eye rotation during lens wear.

In other embodiments, the contact lens may be designed to have a rotation of fewer than 20 degrees within 1 hour of lens wear and less than 180 degrees once per day. It will be appreciated that this contact lens may be still capable of producing a temporally and spatially varying stop signal by a mere random orientation of the lens which is governed by the orientation of the contact lens at the time of insertion.

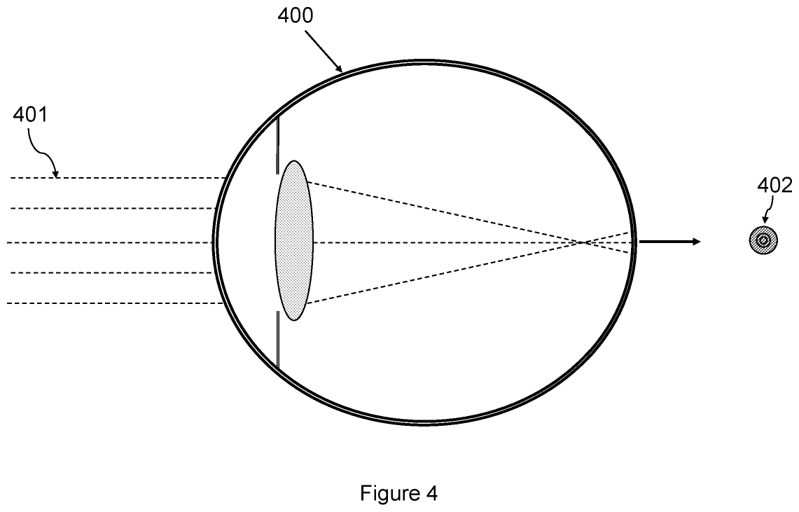

FIG. 4 shows an uncorrected −3 D myopic model eye (400). When incoming light (401) of a visible wavelength (for example, 589 nm) of a vergence 0 D, is incident on the uncorrected myopic eye, the resultant image on the retina has a symmetrical blur (402) caused by defocus. This schematic diagram represents an on-axis, geometric spot analysis at the retinal plane.

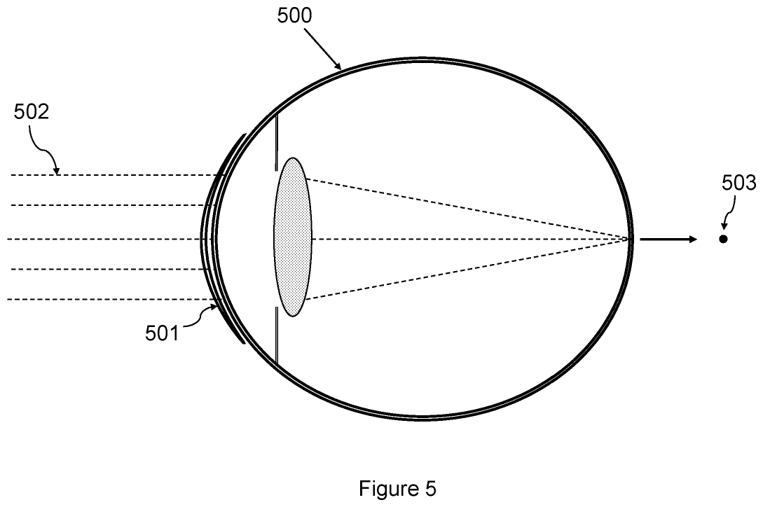

FIG. 5 shows the schematic diagram of an on-axis, geometric spot analysis at the retinal plane when the −3 D myopic model eye (500) of FIG. 4 is corrected with a single vision spherical contact lens of the prior art (501). Here in this example, when the incoming light (502) of a visible wavelength (for example, 589 nm) of a vergence 0 D, is incident on the corrected myopic eye, the resultant image on the retina has a symmetrical sharp focal point (503).

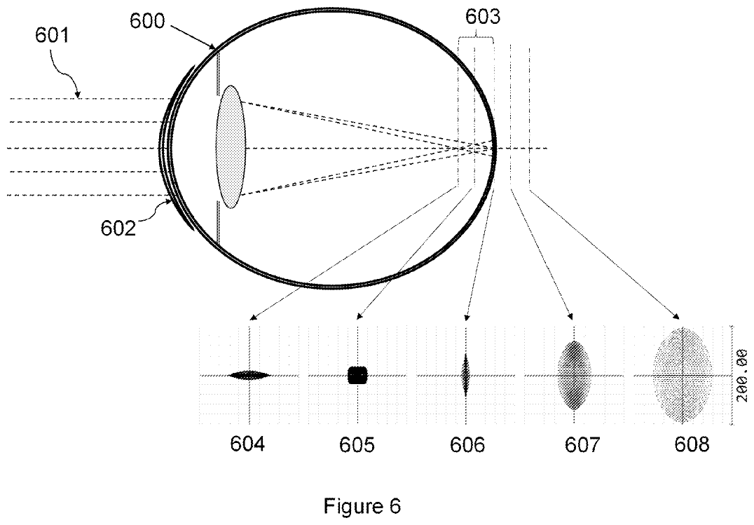

FIG. 6 shows the schematic diagram of an on-axis, through-focus, geometric spot analysis at the retinal plane when the −3 D myopic model eye (600) of FIG. 4 is corrected with a contact lens (602) one of the exemplary embodiments disclosed herein. Here in this example, when the incoming light (601) of a visible wavelength (for example, 589 nm) of a vergence 0 D, is incident on the corrected myopic eye (600), the resultant through-focus images on the retina form a conoid or interval of Sturm (603) having the least circle of confusion (605) and elliptical blur patterns with the tangential and the sagittal planes (604 and 606). The images behind the retina (607 and 608) are both out of focus. In this example, the exemplary embodiment of the disclosure is configured such that the sagittal plane is on the retina, while the tangential plane and circle of least confusion are both in front of the retina. The graph dimension of the blur circle size is 200 μm.

The elliptical blur pattern in the tangential plane (604) is in front of the retina is referred to as meridional astigmatism and the elliptical blur pattern in the sagittal plane (606) is referred to as the meridional correction.

In another example, the contact lens embodiment (602) may be prescribed in a way that the elliptical blur pattern in the tangential plane (604) is in front of the retina and the elliptical blur pattern in the sagittal plane (606) is not behind the retina. The depth of the conoid or interval of Sturm, i.e. the through-focus distance between sagittal and tangential planes may be configured to be between about +0.5 DC to +3 DC. The location of the elliptical blur pattern in the tangential plane (604) may be located between 0.6 mm and 0.13 mm in front of the retina. The location of the elliptical blur pattern in the sagittal plane (606) may be between about 0.13 and 0 mm in front of the retina.

In some examples, the said meridional correction may be limited to sub-foveal, foveal, sub-macular, macular or para-macular regions; while in other examples, the meridional correction may extend to wider field angles on the retina, for example encompassing at least 10 degrees, 20 degrees, or 30 degrees.

In some examples, the said meridional astigmatism may be limited to sub-foveal, foveal, sub-macular, macular or para-macular regions; while in other examples, meridional astigmatism may extend to wider field angles on the retina, for example encompassing at least 10 degrees, 20 degrees, or 30 degrees.

The lateral extent of the optical stop signal on the retina is determined, by either the magnitude of the astigmatic, or toric, or asymmetric, power distribution or the surface area of the said astigmatic, or toric, or asymmetric, power distribution within the optic zone.

Further, due to the rotationally symmetric peripheral carrier zone, the orientation and location of the optical stop stimulus, i.e. the elliptical blur pattern, in front of the retina varies with natural blink action substantially over time. The on-eye rotation and decentration of the contact lens offer a spatially and temporally varying signal.

Specific structural and functional details disclosed in these figures and examples are not to be interpreted as limiting, but merely as a representative basis for teaching a person skilled in the art to employ the disclosed embodiments in numerous other variations.

A schematic model eye (Table 1) was chosen for illustrative purposes in FIGS. 4 to 6. However, in other exemplary embodiments, schematic raytracing model eyes like Liou-Brennan, Escudero-Navarro and others may be used instead of the above simple model eye. One may also alter the parameters of the cornea, lens, retina, ocular media, or combinations thereof, to aid further simulation of the embodiments disclosed herein.

The examples provided herein have used a −3 D myopic model eye to disclose the present invention, however, the same disclosure can be extended to other degrees of myopia, for example, −1 D, −2 D, −5 D or −6 D. Further, it is understood that a person skilled in the art can draw extensions to eyes with varying degrees of myopia in conjunction with astigmatism up to 1 DC. In the example embodiments, reference was made to a specific wavelength of 589 nm, however, it is understood that a person skilled in the art can draw extensions to other visible wavelengths between 420 nm and 760 nm.

Certain embodiments of the present disclosure are directed to contact lenses that may provide a temporally and spatially varying, in other words varying substantially in a retinal location, substantially over time, stop signal to the progressing myopic eye, achieved with the help of the natural on-eye rotation and decentration of the contact lens occurring due to the natural blink action. This temporally and spatially varying stop-signal may minimise the implicit saturation effects of efficacy that are observed in the prior art.

Certain embodiments of the present disclosure are directed to contact lenses that may provide a spatially and temporally varying stop signal to the progressing myopic eye no matter in which orientation the contact lens is worn, or inserted, by the wearer.

In some embodiments of the present disclosure, the stop signal may be configured using an astigmatic, or toric, asymmetric, power profile defined substantially centred about the optic centre or the optical axis. The astigmatic, or toric, power profile may be configured using a radial and/or an azimuthal power distribution along the optic centre.

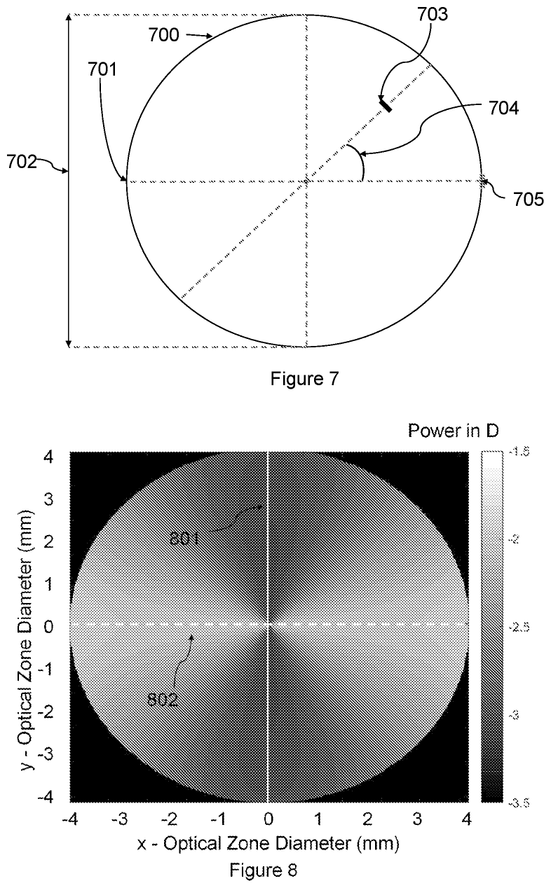

FIG. 7 illustrates schematic diagram (700) of a zoomed-in section of only the optical zone (702) of one of the contact lens embodiments with an astigmatic, a toric, or a sphero-cylindrical prescription (701) of a contact lens embodiment disclosed herein. The power profile distribution within the optical zone of the present embodiment is configured using the radial (703) and azimuthal (704) power distribution functions, as disclosed herein.

In certain embodiments of the present disclosure, the astigmatic, or toric, or asymmetric power distribution may be configured using the below expression: Power distribution of toric embodiment=Sphere+Cylinder/2*(Radial)*(Azimuthal) power distribution functions. In some embodiments, the radial distribution function may take a form of: Radial power distribution=Cρ², where C is the coefficient of the expansion and Rho (φ (703) is the normalised radial co-ordinate ρ₀/ρₘₐₓ. Rho (ρ₀) is the radial coordinate at a given point, whereas ρₘₐₓ is the maximum radial co-ordinate or semi-diameter of the optic zone (705). In some embodiments, the azimuthal power distribution function may take a form of: Azimuthal power distribution=cos mθ, where m can be any integer between 1 and 6 in some embodiments, and Theta (θ) is the azimuthal angle (704).

In certain embodiments of the present disclosure, there may be a need to deal with the fact that most corneas either have some astigmatism or may have ocular astigmatism high enough for requiring correction. The corneal or ocular astigmatism may combine favourably or unfavourably with the contact lens cylinder power and this may lead to varying visual performance of the contemplated embodiments.

Although such a variation of the performance may be beneficial for the treatment or management effect gauged in terms of the efficacy of myopia progression, the variation of the performance may be noticeable or in some cases bothersome to the wearer. Some methods of reducing such variation in visual performance may be achieved by using a toric lens to correct ocular astigmatism.

In such an instance, a stabilised lens may be required and a plurality of contact lenses may be prescribed for an eye of a person or a plurality of pairs of contact lenses applied to the eyes of a person with different cylinder power and/or axis, with specific instructions to rotate the lenses over time.

For example, different pairs of lenses may be worn on different days, weeks, or months. When two or more lenses for each eye are worn under specific instructions, the variation in the design allows to achieve a similar spatial and temporal treatment effect to slow the progression of myopia; wherein the slowing of progression of myopia is substantially consistent over time.

A plurality of contact lenses may not be a preferred embodiment of the disclosure due to the inconvenience it brings for the wearer and the eye care practitioner; however, it is contemplated and captured here to provide a skilled person in art as an alternative method of use of the current invention.

In another embodiment of the present disclosure to tackle the issue of higher amounts of astigmatism that needs correction, for example, at least +1.25 DC, +1.5 DC, +1.75 DC or +2 DC, a spectacle lens may be prescribed to be worn to address the sphero-cylindrical error for the affected eye and a dedicated contact lens may be prescribed to be worn simultaneously with the spectacle lens, with the contact lens configured to induce the desirable levels of astigmatism or toricity to serve as a temporally and spatially varying stop signal.

A schematic model eye was used for simulation of the optical performance results of the exemplary embodiments of the current disclosure (FIGS. 8 to 31). The prescription parameters of the schematic model eye used for optical modelling and simulation of the performance are tabulated in Table 1.

The prescription offers a −3 D myopic eye defined for a monochromatic wavelength of 589 nm. The prescription described in Table 1 should not be construed as an imperative method to demonstrate the effect of the contemplated exemplary embodiment. It is just one of many methods that may be used by the person skilled in the art for optical simulation purposes. The prescription of four (4) exemplary contact lens embodiments are provided in Table 2.

TABLE 1
Prescription of a schematic model eye that offers a −3 D myopic model eye.

| | | | | | Semi | |
|---|---|---|---|---|---|---|
| | | Radius | Thickness | Refractive | Diameter | Conic |
| Type | Comment | (mm) | (mm) | Index | (mm) | Constant |
| Standard | | Infinity | Infinity | | 0.000 | 0.000 |
| Standard | Start | Infinity | 5.000 | | 4.000 | 0.000 |
| Standard | Anterior | 7.750 | 0.550 | 1.376 | 5.750 | −0.250 |
| | Cornea | | | | | |
| Standard | Posterior | 6.400 | 3.000 | 1.334 | 5.500 | −0.400 |
| | Cornea | | | | | |
| Standard | Pupil | Infinity | 0.450 | 1.334 | 5.000 | 0.000 |
| Standard | Anterior | 10.800 | 3.800 | 1.423 | 4.500 | −4.798 |
| | Lens | | | | | |
| Standard | Posterior | −6.250 | 17.775 | 1.334 | 4.500 | −4.101 |
| | Lens | | | | | |
| Standard | Retina | −12.000 | 0.000 | | 10.000 | 0.000 |

The parameters of the model contact lens exemplary embodiment only simulate the optic zone for the performance effects. To demonstrate the performance variation as a function of time, the decentration/tilt functions on the surface have been used to mimic the translation and rotation that would occur physiologically in vivo. For the simulations of the optical performance results, the exemplary embodiments were rotated at 0°, 45°, 90° and 135° or de-centred by ±0.75 mm along the horizontal and vertical meridians.

FIG. 8 illustrates the 2-dimensional power map (in D) of the exemplary embodiment (Example #1) across the 8 mm optic zone diameter. The lens is configured with a sphere power of −3 D and a cylinder power of +1 DC; when the power profile decomposed into two principal meridians, one principle meridian (vertical solid line, 801) has a power of approximately −3D and the other principal meridian (horizontal dashed line, 802) has a power of approximately −2D.

The power variation across the azimuth about the optical centre, the intersection of dashed and sold line, follows a simple cosine distribution, as described herein. The contact lens described in FIG. 8 is configured to provide at least in part foveal correction, or at least in part meridional correction, for a −3 D myopic model eye and further provide an induced or introduced meridional stop signal at the retina of the model eye.

In this example, the principal meridian (801) provides the at least in part meridional correction and the principal meridian (802) provides meridional stop signal at the retina of the model eye.

FIG. 9 illustrates the cross-sectional thickness profiles of an exemplary embodiment of the present invention. The two thickness profiles of perpendicular meridians along the steep (901) and flat (902) section of the optic zone are shown for contact lens Example #1 (FIG. 8).

The sphero-cylindrical power distribution of the contact lens embodiment depicted in FIG. 8 results in an elliptical optical zone with major (902, flat meridian) and minor axes (901, steep meridian). In this exemplary embodiment, the zone between the minor axis (901, steep meridian) and the non-optical peripheral carrier zone (903) results in a stepped transition or blending zone (904).

In this exemplary embodiment, the power variation across the principal meridians of the exemplary embodiment (Example #1) was designed to be minimal (i.e. flat power profile). However, in some other embodiment of the present disclosure, a variation of power across the principle meridians are contemplated. As can be seen in FIG. 9, the peripheral non-optical zone of the lens has a substantially rotationally symmetric carrier zone. This design facilitates the substantially free rotation on or around about the optical centre of the contact lens embodiment (Example #1), due to the natural blink facilitated by the combined action of the upper and lower eyelids, which in turn leads to the astigmatic stimulus imposed by the optical zone to vary with a blink, resulting in a temporally and spatially varying stimulus to reduce the rate of progression of myopia; such that the directional cues and the efficacy to reduce the progression of eye growth remains substantially consistent over time.

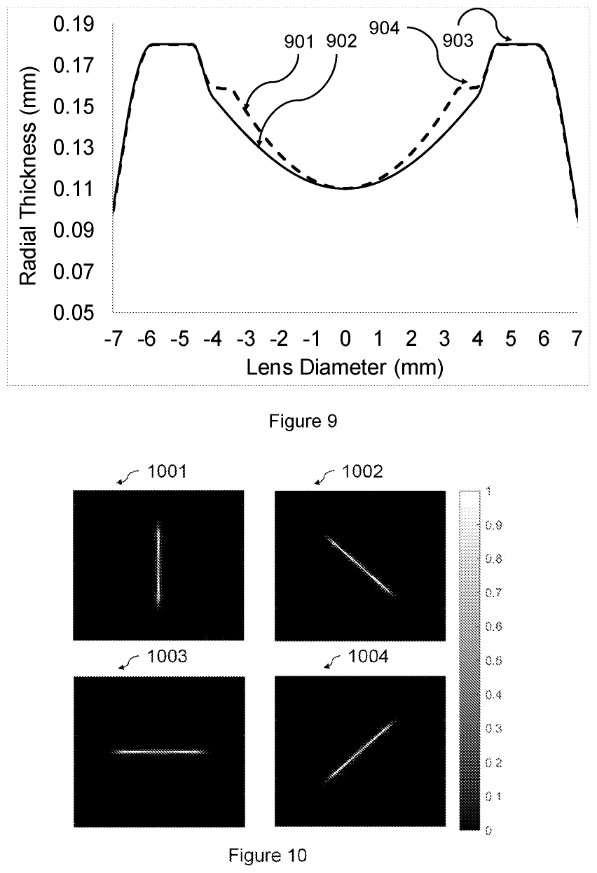

When the incoming light of a visible wavelength (589 nm) of vergence 0 D, is incident on the myopic eye of Table 1 is corrected with the exemplary embodiment (Example #1), the resultant on-axis temporally and spatially varying point spread functions at the retinal plane are illustrated in FIG. 10 with the principal meridian of the lens being located at 0° (1001), 45° (1002), 90° (1003) and 135° (1104).

The rotationally symmetric peripheral carrier zone of the exemplary embodiment (Example #1) facilitates the astigmatic stimulus depicted as point spread function of the sagittal plane on the retina, to vary with natural blink action due to contact lens rotation providing a temporally and spatially varying signal to the eye.

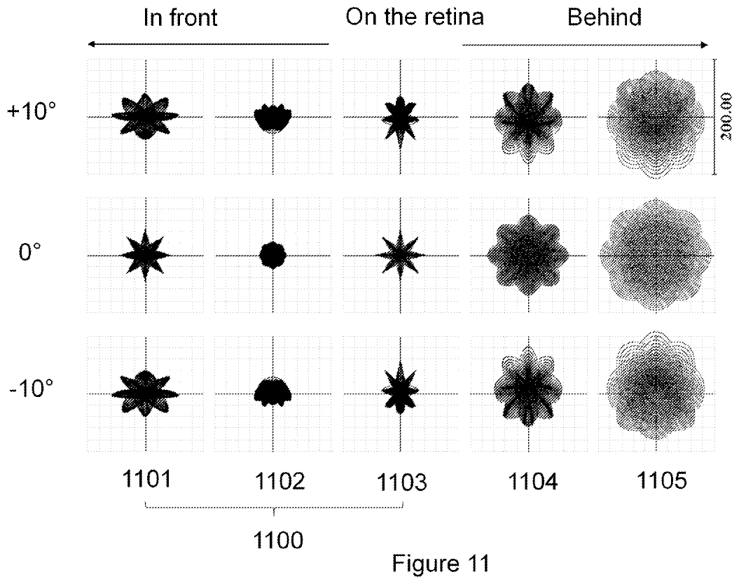

FIG. 11 illustrates the wide-angle (i.e. ±10° visual field), temporally and spatially-varying signal, wherein the principal meridian of the contact lens embodiment is rotated by 0°, 45°, 90° and 135° about the optical centre to simulate contact lens rotation over time.

The through-focus geometric spot diagrams of FIG. 11 are representations of a time integral of the optical stop signal obtained by integrating the resultant responses when the contact lens embodiment is fitted on a −3 D myopic model eye and further rotated at the 4 different configurations (by 0°, 45°, 90° and 135°) emulating the on-eye rotation of the said contact lens resulting in a spatially and temporally varying optical stop signal.

TABLE 2
Prescription of the optical zone of four exemplary
contact lens embodiments of the disclosure.

| | | | | | Semi | |
|---|---|---|---|---|---|---|
| Surface | | Radius | Thickness | Refractive | Diameter | Conic |
| Type | Comment | (mm) | (mm) | Index | (mm) | Constant |
| Example | 1 | | | | | |
| Biconic | Anterior | 8.510 | 0.135 | 1.420 | 4.000 | 0.000 |
| | Contact Lens | | | | | |
| | Surface | | | | | |
| Standard | Posterior | 8.130 | 0.025 | | 4.000 | −0.130 |
| | Contact Lens | | | | | |
| | Surface | | | | | |
| Example | 2 | | | | | |
| Biconic | Anterior | 8.423 | 0.135 | 1.420 | 4.000 | −0.068 |
| | Contact lens | | | | | |
| | Surface | | | | | |
| Standard | Posterior | 8.130 | 0.025 | | 4.000 | −0.130 |
| | Contact Lens | | | | | |
| | Surface | | | | | |
| Example | 3 | | | | | |
| Biconic | Anterior | 8.506 | 0.135 | 1.420 | 4.000 | −0.146 |
| | Contact Lens | | | | | |
| | Surface | | | | | |
| Standard | Posterior | 8.130 | 0.025 | | 4.000 | −0.130 |
| | Contact Lens | | | | | |
| | Surface | | | | | |
| Example | 4 | | | | | |
| Biconic | Anterior | 8.531 | 0.135 | 1.420 | 4.000 | 0.059 |
| | Contact Lens | | | | | |
| | Surface | | | | | |
| Standard | Posterior | 8.130 | 0.025 | | 4.000 | 0.000 |
| | Contact Lens | | | | | |
| | Surface | | | | | |

The through-focus geometric spot analysis about the retinal plane is computed at five (5) locations, 1101 to 1105; wherein the columns 1101 and 1102 represent retinal locations −0.3 mm and −0.1 mm in front of the retina; the columns 1103 represents a location on the retina 0 mm; and the columns 1104 and 1105 represent retinal locations +0.3 mm and +0.1 mm behind the retina.

As can be seen, the through-focus image montage about the retina forms a conoid or interval of Sturm (1100) having elliptical blur patterns encompassing tangential (1101) and sagittal (1103) planes and a circle of least confusion (1102). Behind the retina, the elliptical blur patterns (1104, 1105) keep increasing in size. In a preferred configuration, the contact lens embodiment is prescribed in a way that one of the elliptical foci (tangential) is in front of the retina and the other elliptical foci (sagittal) is on the retina.

The elliptical blur pattern in the tangential plane (1101) is in front of the retina is referred to as meridional astigmatism and the elliptical blur pattern in the sagittal plane (1103) is referred to as the meridional correction. In other examples of the disclosure, the contact lens embodiment may be prescribed in a way that both elliptical foci (tangential and sagittal) are in front of the retina; in this example, the position of the sagittal plane is configured to provide at least in part meridional correction for the eye. In yet another configuration, the contact lens embodiment may be prescribed in a way that one of the elliptical foci (tangential) is in front of the retina and the circle of least confusion is on the retina. Further, in each of these contemplated configurations, by virtue of the rotationally symmetric peripheral carrier zone configured into the contemplated embodiments, the astigmatic or toric optical stimulus in front of the retina, or on the retina, varies with natural blink action due to on-eye contact lens rotation providing a temporally and spatially varying optical signal.

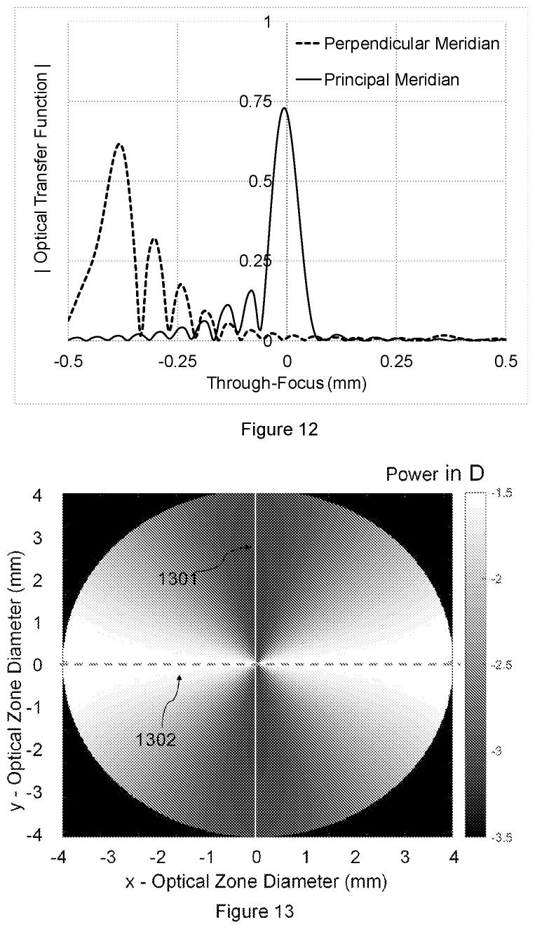

FIG. 12 illustrates the retinal signal depicted as on-axis, through-focus, modulus of the optical transfer function for the principal and perpendicular meridians of the temporally and spatially varying point spread functions; when the incoming light with a visible wavelength (589 nm) and a vergence of 0 D, is incident on a −3 D myopic model eye of Table 1 is corrected with the contact lens embodiment (Example #1) described herein.

In this exemplary embodiment, the peak of the optical transfer function for the principal meridian is located at or slightly in front of the retinal plane, which provides the at least in part foveal, or at least in part meridional correction, for the −3 D myopic eye.

The peak of the optical transfer function for the perpendicular meridian is about 0.38 mm in front of the retina, which provides the induced or introduced meridional stop signal. In this example, the peaks of the principal and perpendicular meridians are synonymous with elliptical blur patterns of sagittal and tangential planes, respectively.

In some other embodiments, the peak of the optical transfer function for the principal meridian may be on the retina and not more than 0.1 mm in front of the retina. In some other embodiments, the peak of the optical transfer function for the perpendicular meridian may be approximately 0.25 mm, 0.35 mm, 0.45 mm, or 0.6 mm in front of the retina. In some embodiments, the distance between the peaks of principal and perpendicular meridians may be optimised to improve visual performance while achieving the desired levels of induced meridional astigmatism contributing towards the optical stop signal.

FIG. 13 illustrates the 2-dimensional power map (in D) of the exemplary embodiment (Example #2) across the 8 mm optic zone diameter. The lens is configured with a sphere power of −3 D and a cylinder power of +1.5 DC; when the power profile decomposed into two principal meridians, one principle meridian (vertical solid line, 1301) has a power of approximately −3D and the other principal meridian (horizontal dashed line, 1302) has a power of approximately −1.5D. The power variation across the azimuth about the optical centre, the intersection of dashed and sold line, follows a simple cosine distribution, as described herein.

The lens has a sphere power of −3 D along one principal meridian which is used for at least in part foveal correction, or at least in part a meridional correction, for the −3 D, myopic model eye described in Table 1 and the astigmatic or toric or cylinder power of +1.5 DC provides the in induced meridional stop signal at the retina of the model eye.

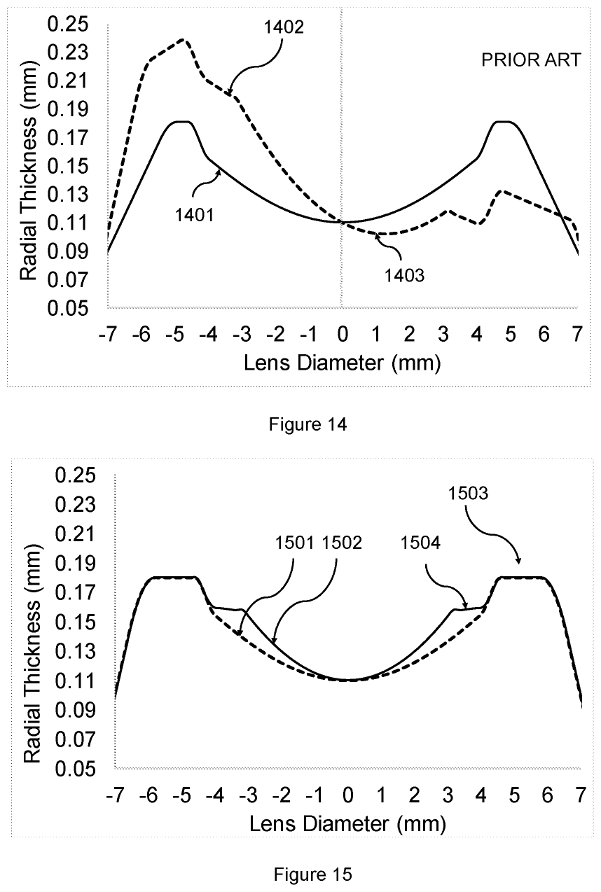

FIG. 14 illustrates the thickness profile of a prior art lens with a toric optic zone. The prior art lens of FIG. 14 has a prism-ballast stabilisation zone. Upon closer inspection of the radial thickness profiles of the vertical and horizontal meridians of a prism ballast lens, which is typical of lenses of the prior art with a prescription of −3.00/+1.50×90°.

The horizontal section (1401) is symmetrical, while the vertical section has a thick inferior (1402) and a thin superior (1403) part to provide a stable orientation when fitted to an eye. The steep thickness curvature in the vertical section and the flat thickness curvature in the horizontal meridian match the required corneal astigmatism and this provides good vision along any meridian.

On the contrary, FIG. 15 illustrates the thickness profile of an exemplary embodiment (Example #2) of the present invention. The two thickness profiles of perpendicular meridians along the steep and flat section of the optic zone are shown for contact lens embodiment (Example #2). The sphero-cylindrical power distribution of the contact lens embodiment depicted in FIG. 13 results in an elliptical optical zone with major (1501, flat meridian) and minor axes (1502, steep meridian).

In this exemplary embodiment, the zone between the minor axis (1502, steep meridian) and the non-optical peripheral carrier zone (1503) results in a stepped transition or blending zone (1504). In this exemplary embodiment, the power variation across the principal meridians of the exemplary embodiment (Example #2) was designed to be minimal (i.e. flat power profile).

As can be seen in FIG. 15, the peripheral non-optical zone of the lens has a substantially rotationally symmetric carrier zone. This design facilitates the substantially free rotation on or around about the optical centre of the contact lens embodiment (Example #2), due to the natural blink facilitated by the combined action of the upper and lower eyelids, which in turn leads to the astigmatic stimulus imposed by the optical zone to vary with a blink, resulting in a temporally and spatially varying stimulus to reduce the rate of progression of myopia in a myopic wearer; wherein the directional cues and the efficiency of reducing the rate of eye growth remains substantially consistent over time.

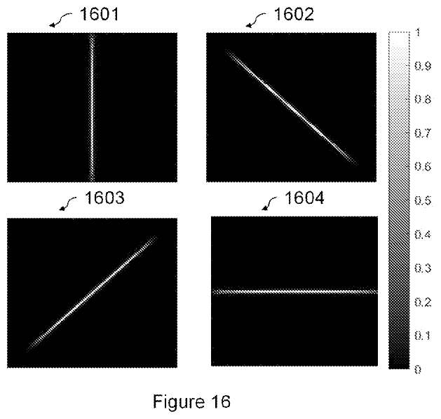

When the incoming light of a visible wavelength (589 nm) of vergence 0 D, is incident on the myopic eye of Table 1 is corrected with the exemplary embodiment (Example #2), the resultant on-axis temporally and spatially varying point spread functions at the retinal plane are illustrated in FIG. 16 with the principal meridian of the lens being located at 0° (1601), 45° (1602), 90° (1603) and 135° (1604). As can be noticed, when compared to the results obtained using Example 1 (FIG. 10), the length of on-axis point spread functions captured at the retina in Example 2 (FIG. 16) are increased, which is due to the increased cylinder power of this contact lens embodiment (Example #2).

The rotationally symmetric peripheral carrier zone of an exemplary embodiment (Example #2) facilitates the astigmatic stimulus depicted as point spread function of the sagittal plane on the retina, to vary with natural blink action due to contact lens rotation providing a temporally and spatially varying signal to the eye.

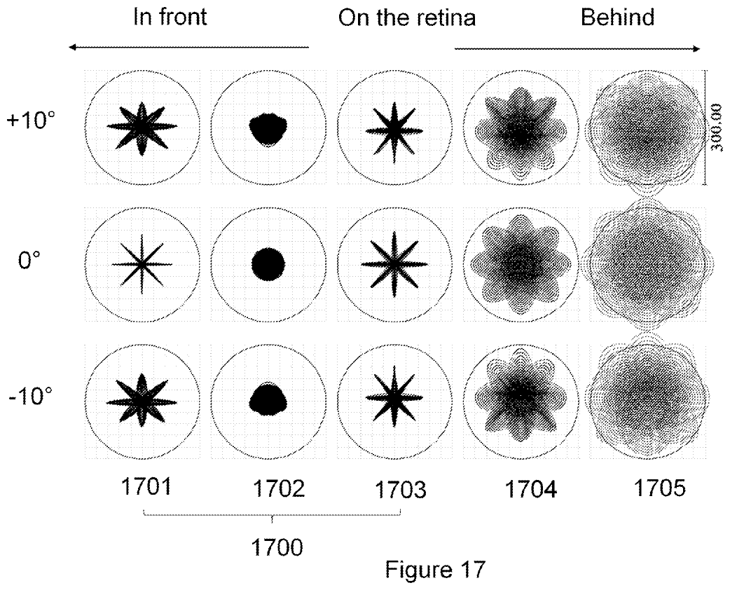

FIG. 17 illustrates the wide-angle (i.e. ±10° visual field), temporally and spatially-varying signal, wherein the principal meridian of the contact lens embodiment (Example #2) is rotated by 0°, 45°, 90° and 135° about the optical centre to simulate contact lens rotation over time. The through-focus geometric spot diagrams of FIG. 17 are representations of a time integral of the optical stop signal obtained by integrating the resultant responses when the contact lens embodiment is fitted on a −3 D myopic model eye and further rotated at the 4 different configurations (by 0°, 45°, 90° and 135°) emulating the on-eye rotation of the said contact lens resulting in a spatially and temporally varying optical stop signal.

The through-focus geometric spot analysis about the retinal plane is computed at five (5) locations, 1701 to 1705; wherein the columns 1701 and 1702 represent retinal locations −0.3 mm and −0.15 mm in front of the retina; the columns 1703 represents a location on the retina 0 mm; and the columns 1704 and 1705 represent retinal locations +0.3 mm and +0.15 mm behind the retina.

As can be seen, the through-focus image montage about the retina forms a conoid or interval of Sturm (1700) having elliptical blur patterns encompassing tangential (1701) and sagittal (1703) planes and a circle of least confusion (1702).

Behind the retina, the elliptical blur patterns (1704, 1705) keep increasing in size. In a preferred configuration, the contact lens embodiment is prescribed in a way that one of the elliptical foci (tangential) is in front of the retina and the other elliptical foci (sagittal) is on the retina.

When compared to Example 1 (FIG. 11) the length of the sagittal and tangential planes, depicted in the through-focus images obtained with Example 2

(FIG. 17), are increased which is due to the increased cylinder power of this lens embodiment (Example #2). The scale of each spot diagram is noted to be 300 μm.

In other examples of the disclosure, the contact lens embodiment may be prescribed in a way that both elliptical foci (tangential and sagittal) are in front of the retina. In yet another configuration, the contact lens embodiment may be prescribed in a way that one of the elliptical foci (tangential) is in front of the retina and the circle of least confusion is on the retina.

Further, in each of these contemplated configurations, by virtue of the rotationally symmetric peripheral carrier zone configured into the contemplated embodiments, the astigmatic or toric optical stimulus in front of the retina, or on the retina, varies with natural blink action due to on-eye contact lens rotation providing a temporally and spatially varying optical signal.

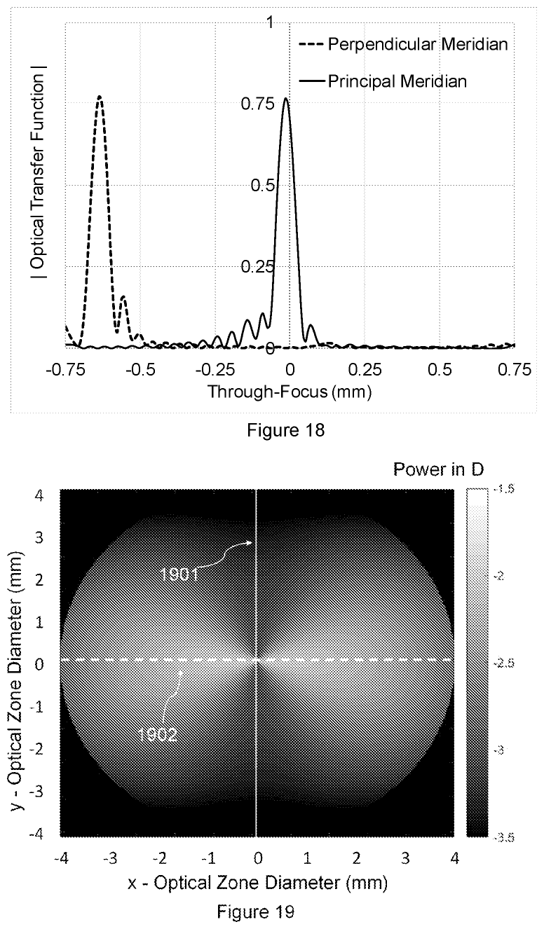

FIG. 18 illustrates the retinal signal depicted as on-axis, through-focus, modulus of the optical transfer function for the principal and perpendicular meridians of the temporally and spatially varying point spread functions; when the incoming light with a visible wavelength (589 nm) and a vergence of 0 D, is incident on a −3 D myopic model eye of Table 1 is corrected with the contact lens embodiment (Example #2) described herein.

In this exemplary embodiment, the peak of the optical transfer function for the principal meridian is located at or slightly in front of the retinal plane, which provides the at least in part foveal, or at least in part meridional correction, for the −3 D myopic eye.

The peak of the optical transfer function for the perpendicular meridian is about 0.64 mm in front of the retina, which provides the induced or introduced meridional stop signal. In this example, the peaks of the principal and perpendicular meridians are synonymous with elliptical blur patterns of sagittal and tangential planes, respectively.

In some other embodiments, the peak of the optical transfer function for the principal meridian may be on the retina and not more than 0.1 mm in front of the retina. In some other embodiments, the peak of the optical transfer function for the perpendicular meridian may be approximately 0.25 mm, 0.35 mm, 0.45 mm, or 0.6 mm in front of the retina. In some embodiments, the distance between the peaks of principal and perpendicular meridians may be optimised to improve visual performance while achieving the desired levels of induced meridional astigmatism contributing towards the optical stop signal.

FIG. 19 illustrates the 2-dimensional power map (in D) of the exemplary embodiment (Example #3) across the 8 mm optic zone diameter. The lens is configured with a sphere power of −3 D and a cylinder power of +1.5 DC; further to the sphero-cylindrical power distribution, the lens is configured with −0.75D of primary spherical aberration defined at the end of the optical zone.

When the power map decomposed into two principal meridians, one principle meridian (vertical solid line, 1901) has a power of approximately −3D with the above-defined magnitude of negative primary spherical aberration defined over the entire optic zone; and the other principal meridian (horizontal dashed line, 1902) has a power of approximately −1.5D with the above-defined magnitude of negative primary spherical aberration defined over the entire optic zone. The power variation across the azimuth about the optical centre, the intersection of dashed and sold line, follows a complex cosine distribution, as described herein.

In some exemplary embodiments, the substantially asymmetric power distribution is expressed using a power distribution function described by the expression Sphere+Azimuthal component, wherein the Sphere refers to the distance spherical prescription power to correct the eye, the Azimuthal component of the power distribution function is described as Cₐ*cos(mθ), wherein Cₐ is an azimuthal coefficient, m is an integer between 1 and 6, and Theta (θ) is the azimuthal angle of a given point of the optic zone.

In some other exemplary embodiments, the substantially asymmetric power distribution is expressed using a power distribution function described by the expression Sphere+(Radial component)*(Azimuthal component), wherein the Sphere refers to the distance spherical prescription power to correct the myopic eye, the Radial component of the power distribution function is described as Cᵣ*ρ, wherein Cᵣ is the coefficient of the expansion and Rho (φ is the normalised radial co-ordinate (ρ₀/μmₐₓ); the Azimuthal component of the power distribution function is described as Cₐ*cos (mθ), wherein m can be any integer between 1 and 6, and Theta (θ) is the azimuthal angle, wherein Rho (ρ₀) is the radial coordinate at a given point, wherein μₘₐₓ is the maximum radial co-ordinate or semi-diameter of the optic zone. The contact lens embodiment of Example #3 is configured to provide at least in part foveal correction, or at least in part a meridional correction, for the −3 D myopic model eye described in Table 1 and the asymmetric power distribution substantially centred about the optical axis (defined a complex cosine distribution about the azimuth) provides the in induced meridional stop signal at the retina of the model eye. In other embodiments of the present disclosure, varying other magnitudes of primary spherical aberrations, for example −0.5D, −1D, −1.25D defined over the entire optic zone of the contact lens may be more desirable. In some other embodiments of the present disclosure, the desired magnitude of positive spherical aberration may be configured over a small area of the optical zone, for example, 5 mm, 6 mm, or 7 mm.

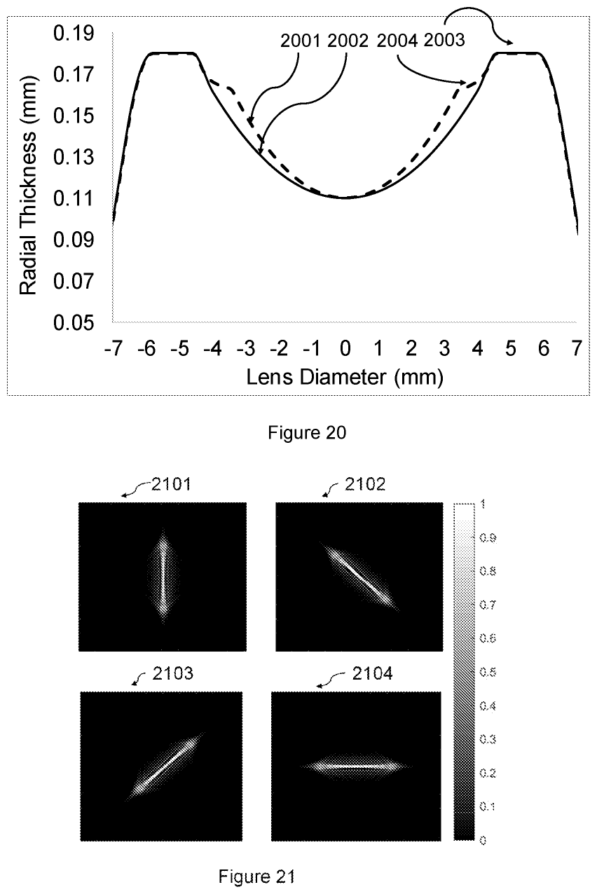

FIG. 20 illustrates the cross-sectional thickness profiles of an exemplary embodiment of the present invention (Example #3). The two thickness profiles of perpendicular meridians along the steep (2001) and flat (2002) section of the optic zone are shown for contact lens Example #3. In this exemplary embodiment, the asymmetric power distribution, which can be represented as complex cosine distribution about the optical centre, defined along the azimuthal direction of the contact lens embodiment depicted in FIG. 19, results in an elliptical optical zone with major (2002, flat meridian) and minor axes (2001, steep meridian).

In this exemplary embodiment, the zone between the minor axis (2001, steep meridian) and the non-optical peripheral carrier zone (2003) results in a stepped transition or blending zone (2004). As can be seen in FIG. 20, the peripheral non-optical zone of the lens has a substantially rotationally symmetric carrier zone. This design facilitates the substantially free rotation on or around about the optical centre of the contact lens embodiment (Example #3), due to the natural blink facilitated by the combined action of the upper and lower eyelids, which in turn leads to the astigmatic stimulus imposed by the optical zone to vary with a blink, resulting in a temporally and spatially varying stimulus to reduce the rate of progression in a myopic wearer, wherein the directional cues and the efficacy to reduce the progression of eye growth remains substantially consistent over time.

When the incoming light of a visible wavelength (589 nm) of vergence 0 D, is incident on the myopic eye of Table 1 is corrected with the exemplary embodiment (Example #3), the resultant on-axis temporally and spatially varying point spread functions at the retinal plane are illustrated in FIG. 21 with the principal meridian of the lens being located at 0° (2101), 45° (2202), 90° (2203) and 135° (2204).

As can be noticed, when compared to the results obtained using Examples 1 and 2 (FIGS. 10 & 16), the length of on-axis point spread functions captured at the retina in Example 3 (FIG. 21) is decreased, which is due to the introduction of negative primary spherical aberration within this contact lens embodiment (Example #3).

The rotationally symmetric peripheral carrier zone of an exemplary embodiment (Example #3) facilitates the astigmatic stimulus depicted as point spread function of the sagittal plane on the retina, to vary with natural blink action due to contact lens rotation providing a temporally and spatially varying signal to the eye.

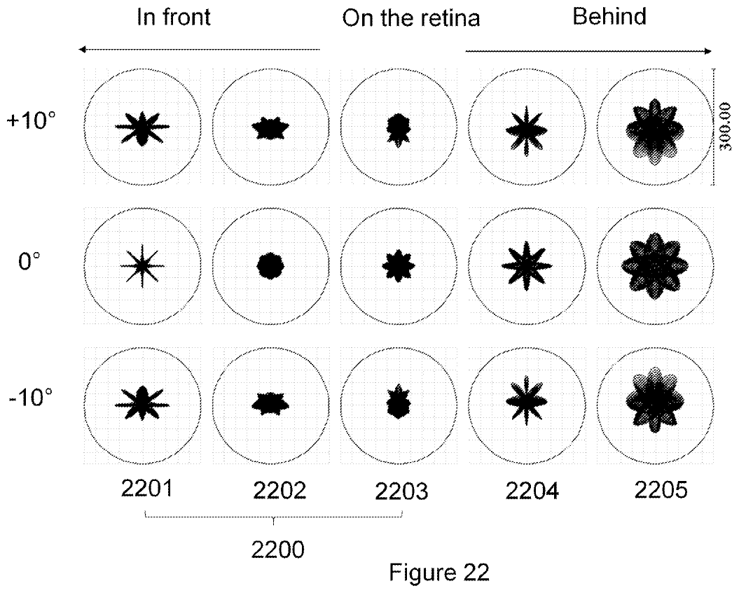

FIG. 22 illustrates the wide-angle (i.e. ±10° visual field), temporally and spatially-varying signal, wherein the principal meridian of the contact lens embodiment (Example #3) is rotated by 0°, 45°, 90° and 135° about the optical centre to simulate contact lens rotation over time.

The through-focus geometric spot diagrams of FIG. 22 are representations of a time integral of the optical stop signal obtained by integrating the resultant responses when the contact lens embodiment is fitted on a −3 D myopic model eye and further rotated at the 4 different configurations (by 0°, 45°, 90° and 135°) emulating the on-eye rotation of the said contact lens resulting in a spatially and temporally varying optical stop signal.

The through-focus geometric spot analysis about the retinal plane is computed at five (5) locations, 2201 to 2205; wherein the columns 2201 and 2202 represent retinal locations −0.3 mm and −0.15 mm in front of the retina; the columns 2203 represents a location on the retina 0 mm; and the columns 2204 and 2205 represent retinal locations +0.3 mm and +0.15 mm behind the retina.

As can be seen, the through-focus image montage about the retina forms a conoid or interval of Sturm (2200) having elliptical blur patterns encompassing tangential (2201) and sagittal (2203) planes and a circle of least confusion (2202).

Behind the retina, the elliptical blur patterns (2204, 2205) keep increasing in size. In a preferred configuration, the contact lens embodiment is prescribed in a way that one of the elliptical foci (tangential) is in front of the retina and the other elliptical foci (sagittal) is on the retina.

When compared to Example 1 & 2 (FIGS. 11 & 17) the length of the sagittal and tangential planes, depicted in the through-focus images obtained with Example 2 (FIG. 17), is reduced due to the introduction of negative primary spherical aberration within this lens embodiment (Example #2). The scale of each spot diagram is noted to be 300 μm. In other examples of the disclosure, the contact lens embodiment may be prescribed in a way that both elliptical foci (tangential and sagittal) are in front of the retina. In yet another configuration, the contact lens embodiment may be prescribed in a way that one of the elliptical foci (tangential) is in front of the retina and the circle of least confusion is on the retina. Further, in each of these contemplated configurations, by virtue of the rotationally symmetric peripheral carrier zone configured into the contemplated embodiments, the asymmetric blur stimulus in front of the retina, or on the retina, varies with natural blink action due to on-eye contact lens rotation providing a temporally and spatially varying optical signal.

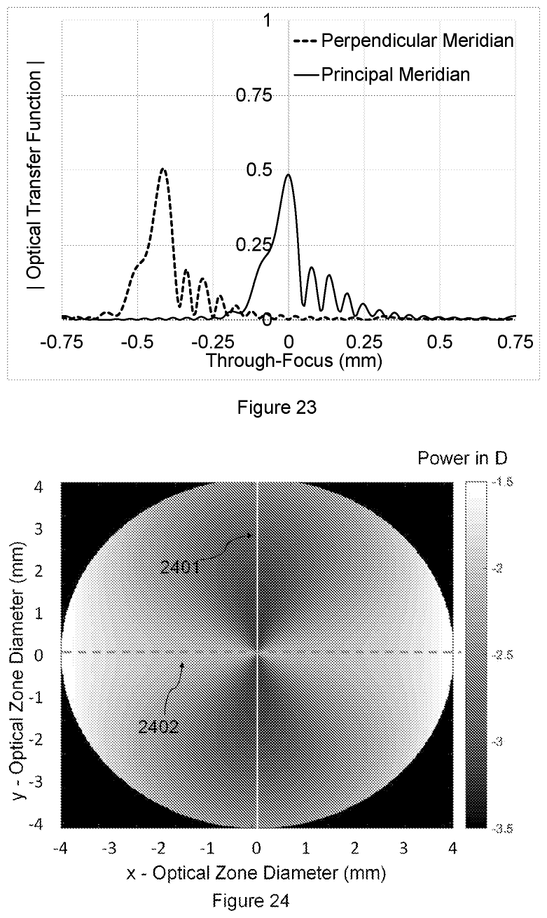

FIG. 23 illustrates the retinal signal depicted as on-axis, through-focus, modulus of the optical transfer function for the principal and perpendicular meridians of the temporally and spatially varying point spread functions; when the incoming light with a visible wavelength (589 nm) and a vergence of 0 D, is incident on a −3 D myopic model eye of Table 1 is corrected with the contact lens embodiment (Example #3) described herein.

In this exemplary embodiment, the peak of the optical transfer function for the principal meridian is located at or slightly in front of the retinal plane, which provides the at least in part foveal, or at least in part meridional correction, for the −3 D myopic eye. The peak of the optical transfer function for the perpendicular meridian is about 0.42 mm in front of the retina, which provides the induced or introduced meridional stop signal. In this example, the peaks of the principal and perpendicular meridians are synonymous with elliptical blur patterns of sagittal and tangential planes, respectively.

In some other embodiments, the peak of the optical transfer function for the principal meridian may be on the retina and not more than 0.1 mm in front of the retina. In some other embodiments, the peak of the optical transfer function for the perpendicular meridian may be approximately 0.25 mm, 0.35 mm, 0.45 mm, or 0.6 mm in front of the retina. In some embodiments, the distance between the peaks of principal and perpendicular meridians may be optimised to improve visual performance while achieving the desired levels of induced meridional astigmatism contributing towards the optical stop signal.

FIG. 24 illustrates the 2-dimensional power map (in D) of the exemplary embodiment (Example #4) across the 8 mm optic zone diameter. The lens is configured with a sphere power of −3 D and a cylinder power of +1.5 DC; further to the sphero-cylindrical power distribution, the lens is configured with +0.75D of primary spherical aberration defined at the end of the optical zone. When the power map decomposed into two principal meridians, one principle meridian (vertical solid line, 2401) has a power of approximately −3D with the above-defined magnitude of positive primary spherical aberration defined over the entire optic zone; and the other principal meridian (horizontal dashed line, 2402) has a power of approximately −1.5D with the above-defined magnitude of positive primary spherical aberration defined over the entire optic zone. The power variation across the azimuth about the optical centre, the intersection of dashed and sold line, follows a complex cosine distribution, as described herein.

In some exemplary embodiments, the substantially asymmetric power distribution is expressed using a power distribution function that is described at least in part using at least one or more of the terms of the Bessel circular functions of the first kind with a generic expression of (n, m); wherein the at least one or more of the terms of the Bessel Circular function are obtained when n takes values of 1, 2, 3 and m takes values of ±2. In some other exemplary embodiments, the azimuthal power distribution function is in a form of cos² (mθ), wherein m is an integer between 1 and 6 inclusive.

The contact lens embodiment of Example #4 is configured to provide at least in part foveal correction, or at least in part a meridional correction, for the −3 D myopic model eye described in Table 1 and the asymmetric power distribution about the optical axis (defined a complex cosine distribution about the azimuth) provides the in induced meridional stop signal at the retina of the model eye.

In other embodiments of the present disclosure, varying other magnitudes of primary spherical aberrations, for example, +0.5D, +1D, +1.25D defined over the entire optic zone of the contact lens may be more desirable. In some other embodiments of the present disclosure, the desired magnitude of positive spherical aberration may be configured over a small area of the optical zone, for example, 5 mm, 6 mm, or 7 mm.

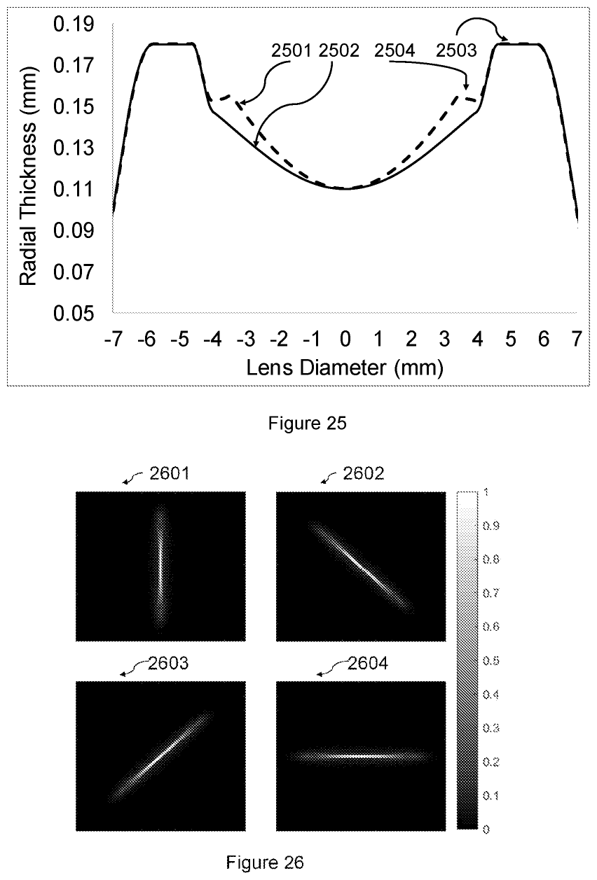

FIG. 25 illustrates the cross-sectional thickness profiles of an exemplary embodiment of the present invention (Example #4). The two thickness profiles of perpendicular meridians along the steep (2501) and flat (2502) section of the optic zone are shown for contact lens Example #4. In this exemplary embodiment, the asymmetric power distribution, which can be represented as complex cosine distribution about the optical centre, defined along the azimuthal direction of the contact lens embodiment depicted in FIG. 24, results in an elliptical optical zone with major (2502, flat meridian) and minor axes (2501, steep meridian). In this exemplary embodiment, the zone between the minor axis (2501, steep meridian) and the non-optical peripheral carrier zone (2503) results in a stepped transition or blending zone (2504).

As can be seen in FIG. 25, the peripheral non-optical zone of the lens has a substantially rotationally symmetric carrier zone. This design facilitates the substantially free rotation on or around about the optical centre of the contact lens embodiment (Example #4), due to the natural blink facilitated by the combined action of the upper and lower eyelids, which in turn leads to the asymmetric stimulus imposed by the optical zone to vary with a blink, resulting in a temporally and spatially varying stimulus to reduce the rate of progression in a myopic wearer, wherein the directional cues and the efficacy to reduce the progression of eye growth remains substantially consistent over time.

When the incoming light of a visible wavelength (589 nm) of vergence 0 D, is incident on the myopic eye of Table 1 is corrected with the exemplary embodiment (Example #4), the resultant on-axis temporally and spatially varying point spread functions at the retinal plane are illustrated in FIG. 26 with the principal meridian of the lens being located at 0° (2601), 45° (2602), 90° (2603) and 135° (2604).

As can be noticed, when compared to the results obtained using Example 3 (FIG. 21), the on-axis point spread functions captured at the retina in Example 4 (FIG. 26) are marginally sharper, which is due to the introduction of positive primary spherical aberration within this contact lens embodiment (Example #4). The rotationally symmetric peripheral carrier zone of an exemplary embodiment (Example #4) facilitates the asymmetric stimulus depicted as point spread function of the sagittal plane on the retina, to vary with natural blink action due to contact lens rotation providing a temporally and spatially varying signal to the eye.

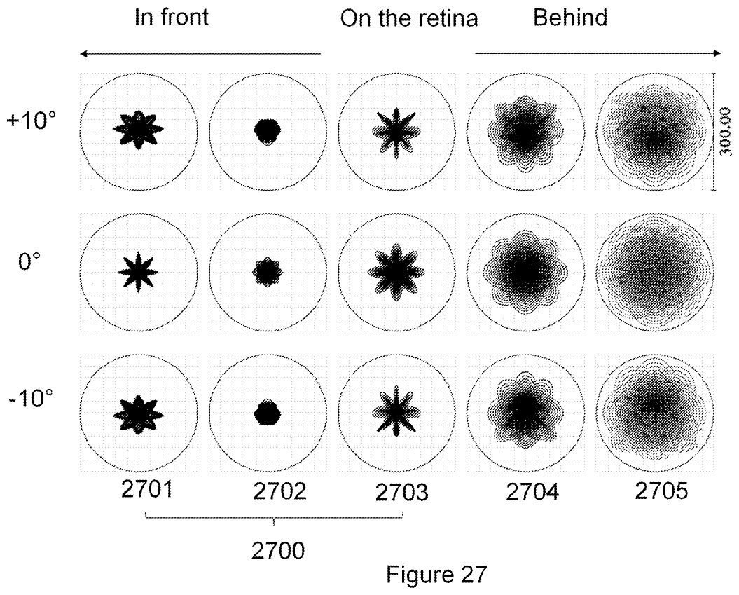

FIG. 27 illustrates the wide-angle (i.e. ±10° visual field), temporally and spatially-varying signal, wherein the principal meridian of the contact lens embodiment (Example #4) is rotated by 0°, 45°, 90° and 135° about the optical centre to simulate contact lens rotation over time. The through-focus geometric spot diagrams of FIG. 27 are representations of a time integral of the optical stop signal obtained by integrating the resultant responses when the contact lens embodiment is fitted on a −3 D myopic model eye and further rotated at the 4 different configurations (by 0°, 45°, 90° and 135°) emulating the on-eye rotation of the said contact lens resulting in a spatially and temporally varying optical stop signal. The through-focus geometric spot analysis about the retinal plane is computed at five (5) locations, 2701 to 2705; wherein the columns 2701 and 2702 represent retinal locations −0.3 mm and −0.15 mm in front of the retina; the columns 2703 represents a location on the retina 0 mm; and the columns 2704 and 2705 represent retinal locations +0.3 mm and +0.15 mm behind the retina. As can be seen, the through-focus image montage about the retina forms a conoid or interval of Sturm (2700) having elliptical blur patterns encompassing tangential (2701) and sagittal (2703) planes and a circle of least confusion (2702). Behind the retina, the elliptical blur patterns (2704, 2705) keep increasing in size. In a preferred configuration, the contact lens embodiment is prescribed in a way that one of the elliptical foci (tangential) is in front of the retina and the other elliptical foci (sagittal) is on the retina. When compared to Example 2 (FIG. 17) the through-focus images in Example 4 (FIG. 27) are slightly increased which is due to the negative spherical aberration of this lens. The scale of each spot diagram is noted to be 300 μm.

In other examples of the disclosure, the contact lens embodiment may be prescribed in a way that both elliptical foci (tangential and sagittal) are in front of the retina. In yet another configuration, the contact lens embodiment may be prescribed in a way that one of the elliptical foci (tangential) is in front of the retina and the circle of least confusion is on the retina. Further, in each of these contemplated configurations, by virtue of the rotationally symmetric peripheral carrier zone configured into the contemplated embodiments, the asymmetric blur stimulus in front of the retina, or on the retina, varies with natural blink action due to on-eye contact lens rotation providing a temporally and spatially varying optical signal.

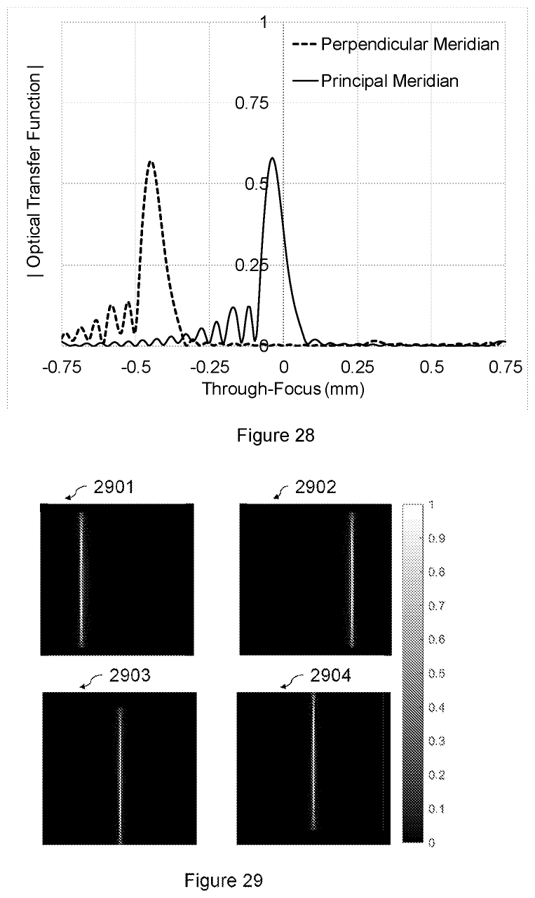

FIG. 28 illustrates the retinal signal depicted as on-axis, through-focus, modulus of the optical transfer function for the principal and perpendicular meridians of the temporally and spatially varying point spread functions; when the incoming light with a visible wavelength (589 nm) and a vergence of 0 D, is incident on a −3 D myopic model eye of Table 1 is corrected with the contact lens embodiment (Example #4) described herein. In this exemplary embodiment, the peak of the optical transfer function for the principal meridian is located at or slightly in front of the retinal plane, which provides the at least in part foveal, or at least in part meridional correction, for the −3 D myopic eye. The peak of the optical transfer function for the perpendicular meridian is about 0.45 mm in front of the retina, which provides the induced or introduced meridional stop signal. In this example, the peaks of the principal and perpendicular meridians are synonymous with elliptical blur patterns of sagittal and tangential planes, respectively. In some other embodiments, the peak of the optical transfer function for the principal meridian may be on the retina and not more than 0.1 mm in front of the retina. In some other embodiments, the peak of the optical transfer function for the perpendicular meridian may be approximately 0.25 mm, 0.35 mm, 0.45 mm, or 0.6 mm in front of the retina. In some embodiments, the distance between the peaks of principal and perpendicular meridians may be optimised to improve visual performance while achieving the desired levels of induced meridional astigmatism contributing towards the optical stop signal. When the incoming light of a visible wavelength (589 nm) of vergence 0 D, is incident on the myopic eye of Table 1 is corrected with the exemplary embodiment (Example #2), the resultant on-axis decentred point spread functions with the lens being decentred by 0.75 mm (2901) and −0.75 mm (2902) along the x-axis and by 0.75 mm (2903) and by −0.75 mm (2904) along the y-axis at the retinal plane is illustrated in FIG. 29.

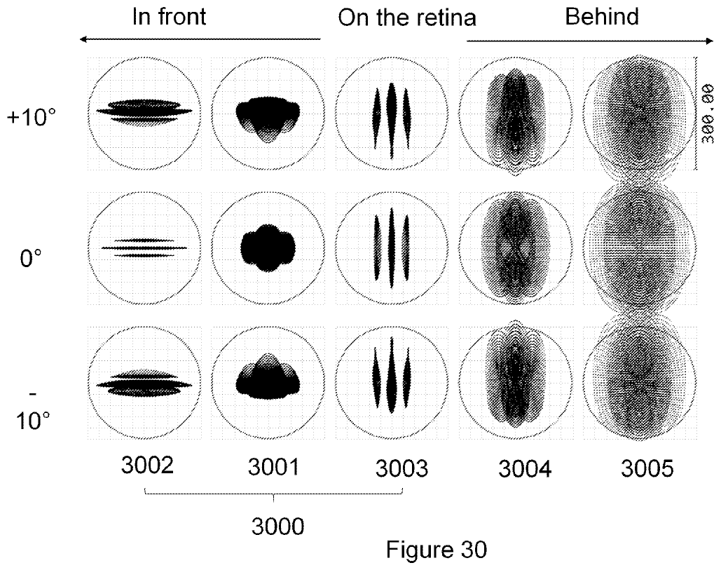

FIG. 30 illustrates the wide-angle (i.e. ±10° visual field), temporally and spatially varying (i.e. with the lens being decentred by ±0.75 mm along the x- and y-axis over time), geometric spot analysis about the retinal plane; when the −3 D myopic model eye of Table 1 is corrected with one of the exemplary embodiments (Example #2) disclosed herein. The through-focus geometric spot diagrams of FIG. 30 are representations of a space integral of the optical stop signal obtained by integrating the resultant responses, when the contact lens embodiment is fitted on a −3 D myopic model eye and further decentred at the 2 different configurations (±0.75 mm along the x- and y-axis) emulating the on-eye rotation of the said contact lens resulting in a spatially and temporally varying optical stop signal.

As can be seen, the through-focus image montage about the retina forms a conoid or interval of Sturm (3000) having elliptical blur patterns with sagittal (3002) and tangential (3003) planes and a circle of least confusion (3001). Behind the retina, the blur patterns (3004, 3005) keep increasing in size. The contact lens embodiment is prescribed in a way that one of the elliptical foci are in front of the retina. Further, due to the rotationally symmetric peripheral carrier zone, the stimulus in front of the retina varies with natural blink action, i.e. in this exemplary embodiment due to lens decentration (temporally and spatially varying signal).

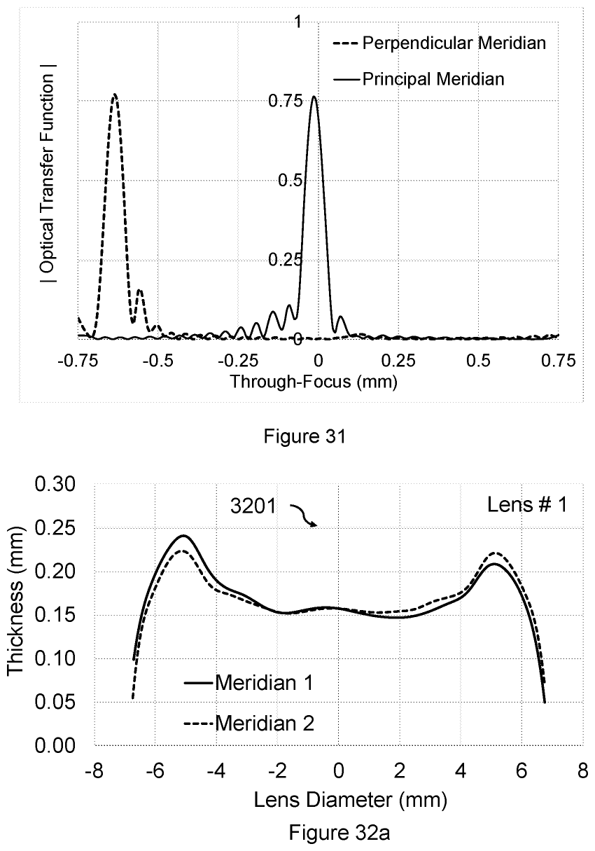

FIG. 31 illustrates the retinal signal depicted as on-axis, through-focus, modulus of the optical transfer function for the principal and perpendicular meridians of the temporally and spatially varying point spread functions when the lens is decentred; when the incoming light with a visible wavelength (589 nm) and a vergence of 0 D, is incident on a −3 D myopic model eye of Table 1 is corrected with the contact lens embodiment (Example #2) described herein. The peak of the optical transfer function for the principal meridian is located at or slightly in front of the retinal plane, which provides the meridional correction for the −3 D myopic eye. The peak of the optical transfer function for the perpendicular meridian is about 0.64 mm in front of the retina, which provides the induced meridional stop signal.

In certain other embodiments, a change or substantial change to the optical signal received by the on- and off-axis region on the retina, configured by conoid or interval of Sturm, where the optical stop signal means a portion of the conoid or interval of Sturm falls in front of the retina, while the remainder of the conoid or interval of Sturm about the retina. The proportion of the conoid or interval of Sturm that provides a meridional stop signal, may be approximately 10%, 20%, 30% 40%, 50%, 60%, 70%, 80%, 90% or 100%.

In certain embodiments, the astigmatic, or toric, a portion of the optical zone of a contact lens embodiment provides at least in part, a meridional correction for a myopic eye and at least in part, meridional stop signal to reduce the rate of myopia progression. The introduced or induced astigmatism, optical stop signal, maybe at least +0.5 DC, +0.75 DC, +1 DC, +1.25 DC, +1.5 DC, +1.75 DC, +2 DC, +2.25 DC or +2.5 DC.

In certain embodiments, the surface area defined by the minor and major axes of the astigmatic, or toric, a portion of the optical zone of a contact lens embodiment providing at least in part, a meridional correction for a myopic eye, and at least in part, meridional stop signal to reduce the rate of myopia progression may be at least 30%, 40%, 50%, 60%, 70%, or 80%.

In certain other embodiments, the desired prescription of the introduced or induced astigmatism, optical stop signal, may be represented in the negative cylinder format. For example, the prescription in the negative cylinder form for an embodiment of the present disclosure aimed to correct and manage a −3 D myopic model eye would be −2D sphere power and −1DC cylinder power; in this example, the embodiment would provide a partial foveal correction, or at least in part meridional correction, for the myopic model eye, and further provides at least 1DC astigmatic blur (i.e. stop signal) to the myopic eye.

In certain embodiments, the induced astigmatism in the toric optical zone of the contact lens may be at least +0.5 DC, +0.75 DC, +1 DC, +1.25 DC, +1.5 DC, +1.75 DC, +2 DC, +2.25 DC or +2.5 DC. In certain embodiments, the induced astigmatism in the toric optical zone of the contact lens may be between +0.50 DC and +0.75 DC, +0.5 DC and +1 DC, and +0.5 DC and +1.25 DC, +0.5 DC and 1.5 DC, 0.5 DC and 1.75 DC, 0.5 DC and 2 DC, 0.5 DC and 2.25 DC or 0.5 DC and 2.5 DC.

In certain embodiments, the toric optical zone of the contact lens may be at least 6 mm, 6.5 mm, 7 mm, 7.5 mm, 8 mm, 8.5 mm, or 9 mm in diameter. In certain embodiments, the toric optical zone of the contact lens may be between 6 mm to 7 mm, 7 mm to 8 mm, 7.5 mm to 8.5 mm, or 7 to 9 mm in diameter.

In certain embodiments, the blend zone or blending zone of the contact lens may be at least 0.05 mm, 0.1 mm, 0.15 mm, 0.25 mm, 0.35 or 0.5 mm in width.

In certain embodiments, the blend zone or blending zone of the contact lens may be between 0.05 mm and 0.15 mm, 0.1 mm and 0.3 mm, or 0.25 mm and 0.5 mm in width. In some embodiments, the blending zone may be symmetrical and yet in some other embodiments, the blending zone may be asymmetrical, for example, elliptical. In certain other embodiments, a person skilled in the art may consider practising the current invention without using blend zones or blending zones.

In certain embodiments, a substantial portion of the optical zone of the contact lens made up with a toric correction, defined substantially concentric about the optical axis or optical centre, may be understood to mean at least 50%, 60%, 70%, 80%, 90%, 95%, 98%, or 100% of the optical zone of the contact lens. In certain embodiments, a substantial portion of the optical zone of the contact lens made up with toric correction, defined substantially concentric about the optical axis or optical centre, may be understood to mean between 50% and 70%, between 60% and 80%, between 60% and 90%, between 50% and 95%, between 80% to 95%, between 85% and 98% or between 50% and 100% of the optical zone of the contact lens.

In certain embodiments, the peripheral non-optical zone or carrier zone of the contact lens may be at least 2.25 mm, 2.5 mm, 2.75 mm, or 3 mm in width. In certain embodiments, the peripheral zone or carrier zone of the contact lens may be between 2.25 mm and 2.75 mm, 2.5 mm and 3 mm, or 2 mm and 3.5 mm in width. In certain embodiments, the peripheral zone or the carrier zone of the contact lens is substantially symmetric with substantially similar radial thickness profiles across horizontal, vertical, and other oblique meridians.

In certain embodiments, the peripheral zone or the carrier zone of the contact lens is substantially symmetric with substantially similar radial thickness profiles across horizontal, vertical and other oblique meridians, which may mean that the thickness profiles of the peripheral carrier zone across any of the half meridians are within 7%, 9%, 11%, 13%, or 15%, a variation of the thickness profile of any other half meridian. Wherein the radial thickness profile being compared between different any of the meridians is measured at the radial distance.

In certain embodiments, the peripheral zone or the carrier zone of the contact lens is substantially symmetric with substantially similar radial thickness profiles across horizontal, vertical and other oblique meridians, which may mean that the thickness profiles of the peripheral carrier zone across any of the meridians are within 7%, 9%, 11%, 13%, or 15%, a variation of the thickness profile of any other meridian. Wherein the radial thickness profile being compared between different any of the meridians is measured at the radial distance. In certain embodiments, the peripheral zone or the carrier zone of the contact lens is substantially rotationally symmetric with substantially similar radial thickness profiles across horizontal, vertical and other oblique meridians, which may mean that the thickest point within the peripheral carrier zone across any of the half meridians is within a maximum variation of 10, 15, 20, 25, 30, 35, or 40 μm of the thickest peripheral point of any other half meridian. For the avoidance of doubt, the thickness profile is measured in the radial direction.

In certain embodiments, the peripheral zone or the carrier zone of the contact lens is substantially rotationally symmetric with substantially similar radial thickness profiles across horizontal, vertical and other oblique meridians, which may mean that the thickest point within the peripheral carrier zone across any of the meridians is within a maximum variation of 10, 15, 20, 25, 30, 35, or 40 μm of the thickest peripheral point of any other meridian. For the avoidance of doubt, the thickness profile is measured in the radial direction. In certain embodiments, the peripheral zone or the non-optical carrier zone of the contact lens is configured to be substantially free of a ballast, free of any optical prism, free of a prism ballast, free of a slab-off design, or free of a truncated design, which is commonly used in conventional toric contact lenses or asymmetric contact lenses aimed at stabilising the orientation of the contact lens on the eye.

In certain embodiments, substantially free rotation of the contact lens over time may be a rotation by 180 degrees, at least once, twice, thrice, four, five or ten times per day and at least 10, 15, 20, or 25 degrees within 1 hour of lens wear. In other embodiments, substantially free rotation of the contact lens over time may be a rotation by 90 degrees, at least once, twice, thrice, four, five or ten times per day and at least 10, 15, 20, or 25 degrees within 2 hours of lens wear. In some embodiments, the toric part of the contact lens can be located, formed, or placed on the anterior surface, posterior surface, or combinations thereof. In some embodiments, the toric part of the contact lens, defined substantially concentric about the optical axis or optical centre of the contact lens, is devoted to producing specific features of the stop-signal, for example, induced astigmatism with either the sagittal or tangential focal line substantially in front of the retina.

In certain other examples, the toric part of the contact lens located, formed, or placed on one of the two surfaces of the contact lens and the other surface may have other features for further reducing eye growth. For example, use of additional optical features like coma, trefoil, or primary spherical aberration to improve the visual performance with the embodiments while offering a directional cue or stop signal for reducing the rate of growth of the eye.

In certain embodiments, the shape of the optical zone, the blending zones and/or the peripheral carrier zone may be described by one or more of the following: a sphere, an asphere, an extended odd polynomial, an extended even polynomial, a conic section, a biconic section, a toric surface or a Zernike polynomial.

In some other embodiments, the radial and/or azimuthal power distribution across the optic centre may be described by appropriate Bessel functions, Jacobi polynomials, Taylor polynomials, Fourier expansion, or combinations thereof. In one embodiment of the present disclosure, the stop signal may be configured using solely astigmatism, astigmatic or toric power profiles. However, in other embodiments, higher-order aberrations like primary spherical aberration, coma, trefoil, may be combined with the configured astigmatic, toric, or asymmetric blur. As a person skilled in the art may appreciate, the present invention may be used in combination with any of the devices/methods that have the potential to influence the progression of myopia.

These may include but are not limited to, spectacle lenses of various designs, colour filters, pharmaceutical agents, behavioural changes, and environmental conditions.

### Prototype Contact Lenses Lens #1 and Lens #2: Design, Metrology and Clinical Data

Two toric contact lenses with rotationally symmetric peripheral carrier zones were manufactured in the prescription for the right and left eyes of one subject to assess the visual performance and to gauge the amount of rotation of the lenses when worn on the eye over time.

Lens #1 and Lens #2 are exemplary embodiments of the invention, as disclosed herein. Both lenses (Lens #1 and Lens #2) had a sphere power of −2.00 D and a cylinder power of +1.50 DC. However, the contact lens embodiments incorporated meridional negative spherical aberration, wherein the magnitude of spherical aberration was chosen such that the principle meridian configured with positive cylindrical was blended into a sphere at the end of the optic zone. This method reduced the average cylinder power over the 8 mm optic zone to approximately +0.8 DC. Both lenses provided clinically acceptable visual performance when compared to single vision correction.

Table 4 shows the measured base curve, lens diameter and centre thickness values of the two manufactured lenses, i.e. Lens #1 for the right and Lens #2 for the left eye. The contact lens material was Contaflex 42 (Contamac, UK) which has a measured refractive index of 1.432.

TABLE 4
Measured base curve, diameter and centre thickness
values for Lens #1 and Lens #2.

| | | Base | Diameter | Centre |
|---|---|---|---|---|
| | Eye | curve (mm) | (mm) | thickness (mm) |
| Lens | Right | 8.51 | 13.751 | 0.120 |
| #1 | | | | |
| Lens | Left | 8.66 | 13.797 | 0.127 |
| #2 | | | | |

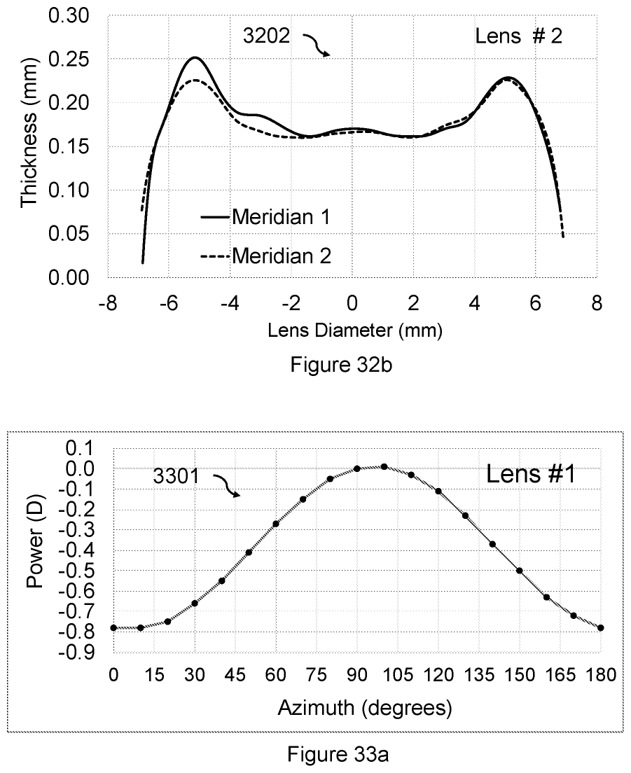

FIGS. 32a and 32b illustrate the measured thickness profiles of two perpendicular meridians of the two prototype contact lenses Lens #1 (FIG. 32a) and Lens #2 (FIG. 32b), which are a variant of a contact lens embodiment described in FIG. 19.

The thickness profiles were measured with Optimec is830 (Optimec Ltd, UK) and the peripheral prisms, i.e. thickness difference between the two peripheral peaks of the meridians of each lens were determined. In Lens #1 (3201), the thickness differences were 32.5 μm and 2.3 μm for Meridians 1 and 2, respectively. Similarly, in Lens #2 (3020) the thickness differences were 22.9 μm and 0.4 μm for Meridians 1 and 2, respectively.

As expected from the design of the peripheral rotationally symmetric carrier zones of these prototype contact lenses, the peripheral thickness differences across both meridians were minimal, providing a peripheral carrier zone without rotational stabilisation.

While Optimec is830 permits reliable measurements for the peripheral thickness profiles, in the central optic zone the measurement variability of the instrument is increased and the expected thickness difference between the vertical and horizontal meridians of the toric optic zones of Lens #1 and Lens #2 cannot be appreciated from these measurements. Instead, the power mapping instrument NIMOevo (Lambda-X, Belgium) was used to measure and confirm the cylinder power of the central optic zones of Lens #1 and Lens #2.

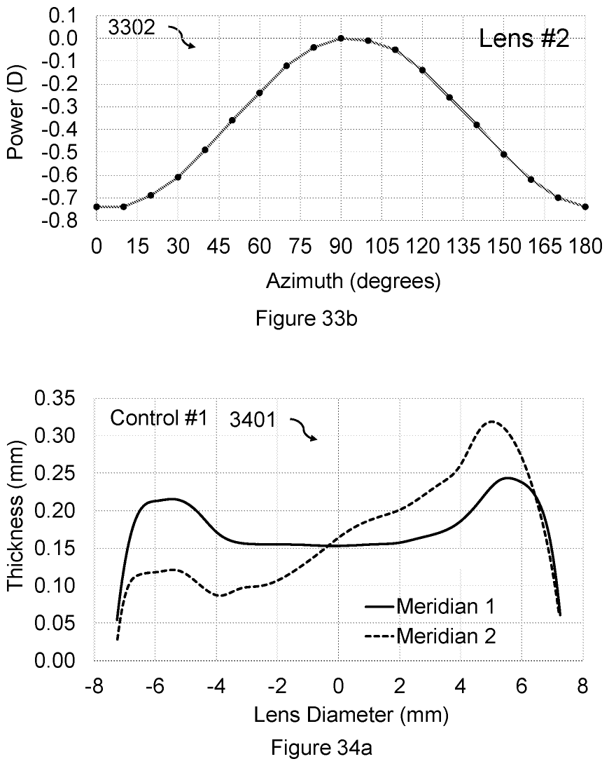

FIGS. 33a and 33b illustrate the measured relative meridional powers from NIMOevo after a cosine was fit to the data for the two prototype contact lenses Lens #1 (3301) and Lens #2 (3302), which are a variant of a contact lens embodiment described in FIG. 19. The measured cylinder powers for Lens #1 and Lens #2 were 0.78 DC and 0.74 DC, respectively for an 8 mm aperture, which is in line with the expected cylinder power (i.e. cylinder power plus meridional negative spherical aberration).

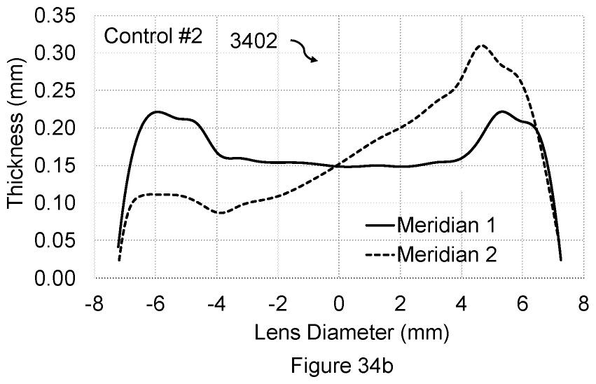

FIGS. 34a and 34b illustrate the measured thickness profiles of the vertical and horizontal meridians for two commercially available toric contact lenses (Control #1 and Control #2). For the avoidance of doubt, Control #1 and Control #2 are examples of the prior art lenses. The lenses were Biofinity Toric lenses (CooperVision, US) (material: comfilcon A) with a cylinder power of −1.25 DC.

In this example, the thickness profiles were measured with Optimec is830 (Optimec Ltd, UK) and the peripheral prisms, i.e. thickness difference between the two peripheral peaks of the meridians, of each lens were determined. In Control #1 (3401), the thickness differences were 197.5 μm and 28 μm for Meridians 1 (vertical) and 2 (horizontal), respectively. In Control #2 (3402), the thickness differences were 198.5 μm and 0.03 μm for Meridians 1 and 2, respectively. Unlike the thickness profiles and differences of the prototype contact lenses Lens #1 (3201) and Lens #2 (3202) which were similar for both meridians, the two commercially available toric contact lenses Control #1 (3401) and Control #2 (3402) showed significant peripheral prisms along Meridian 2. These peripheral prisms have the purpose to stabilise a toric contact lens (prior art).

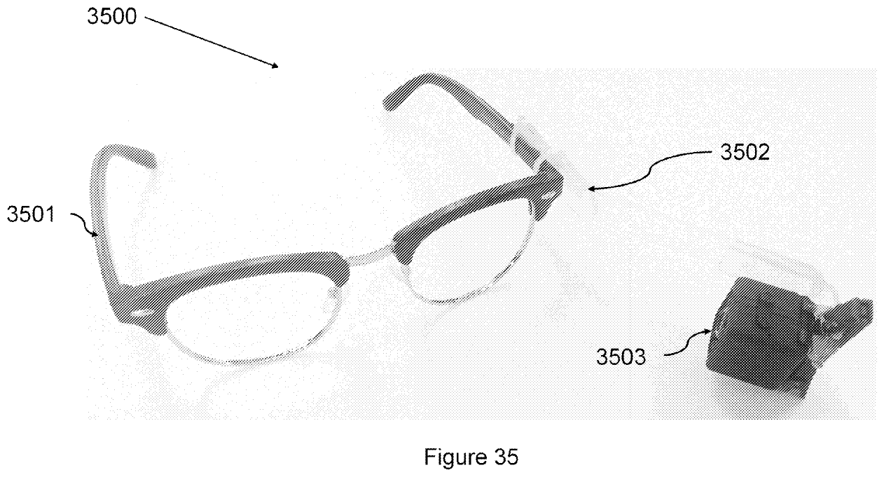

FIG. 35 shows a picture of a device (3500) used for the measurement of contact lens rotation over time. The device (3500) consists of a simple spectacle frame (3501) to which a mounting arm with a small camera (3503) (SQ11 Mini HD camera) was attached to. The camera was positioned so that a video of the contact lens when worn on the eye could be taken over time, to assess the rotation of a contact lens embodiment disclosed herein, i.e. the spatially and temporally varying stimulus.

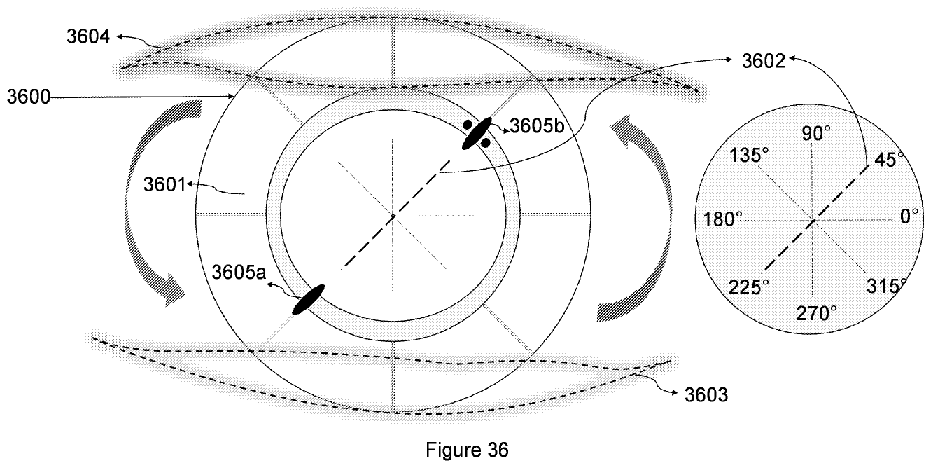

FIG. 36 shows the frontal view of a contact lens embodiment disclosed herein (3600) comprising a symmetric non-optical peripheral carrier zone (3601) under the influence of lower (3603) and upper (3604) eyelids allowing for free rotation of the contact lens embodiment on or about its optical centre. The frontal view further illustrates a method, i.e. two different markings along the same meridian on the contact lens embodiment (3605a and 3605b), which in conjunction with a device (3500) can be used to measure the azimuthal contact lens position (3602) over time, i.e. the amount of rotation. In this exemplary embodiment (3600), the contact lens marking (3605b) was located along the 45° meridian. In other embodiments, the markings may be of different shape, size or colour, and the number of markings may be more than 2 to provide additional ease in detecting the azimuthal contact lens position over time.

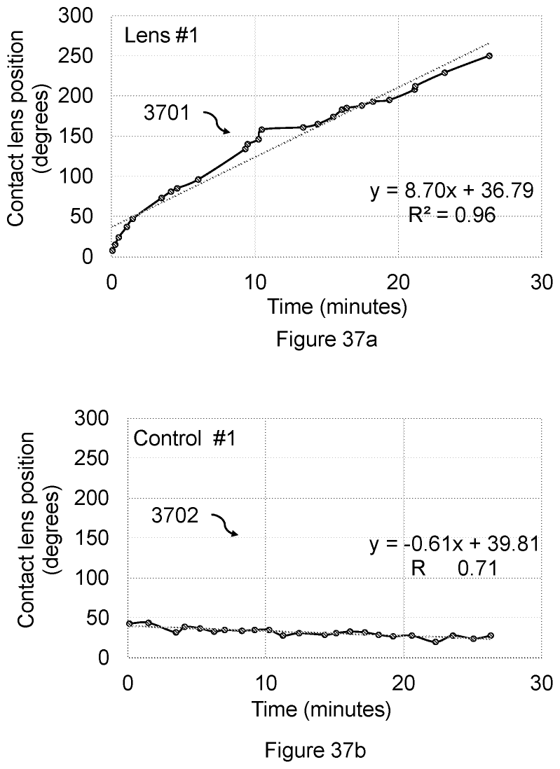

FIGS. 37a and 37b show the measured azimuthal position of the prototype contact Lens #1 (3701) and the commercially available toric contact lens Control #1 (3702) over time, i.e. about 30 minutes of lens wear when wearing the described device (3500) and following the described method (3600). Unlike the commercially available toric contact lens Control #1 which only showed a small amount of lens rotation, the prototype contact Lens #1 rotated by about 250° after approximately 25 minutes of lens wear. In some embodiments, the contact lens may be configured with a specific fit that allows substantially free rotation of the contact lens on the myopic eye; wherein the substantially free rotation of the contact lens is gauged as a rotation of the contact lens by 180 degrees at least once, twice, thrice, four or five times per day and at least 15, 20, 25, 30 or 35 degrees within 1 hour of lens wear. Few other exemplary embodiments are described in the following examples sets.

### Example Set “A”—Astigmatic Power Distribution

A contact lens for an eye, the contact lens including an optical zone around an optical centre and a non-optical peripheral carrier zone about the optical zone; wherein the optical zone is configured with a substantially toric or astigmatic power distribution centred substantially about the optical centre, providing at least in part a meridional correction for the eye, and providing at least in part meridional astigmatism producing direction cues to serve as a stop signal for the eye; and wherein the non-optical peripheral carrier zone is configured with a thickness profile that is substantially rotationally symmetric about the optical centre.

The contact lens of one or more claims of the example set A, wherein an area of the optical zone configured with the substantially toric or astigmatic power distribution comprises at least 50% of the optical zone and the remainder of the optic zone is configured with spherical correction for the eye.

The contact lens of one or more claims of the example set A, wherein the meridional correction and meridional astigmatism provided by a region of the optical zone configured with the substantially toric or astigmatic power distribution that extends across at least 4 mm of a central region of the contact lens.

The contact lens of one or more claims of the example set A, wherein the substantially toric or astigmatic power distribution of the optical zone is configured on an anterior surface of the contact lens.

The contact lens of one or more claims of the example set A, wherein the substantially toric or astigmatic power distribution of the optical zone is configured on a posterior surface of the contact lens.

The contact lens of one or more claims of the example set A, wherein the substantially toric or astigmatic power distribution of the optical zone is configured in part by an anterior surface and in part by a posterior surface of the contact lens.

The contact lens of one or more claims of the example set A, wherein a thickest point within the non-optical peripheral carrier zone across any of the one half meridian is within a maximum variation of 30 μm of the thickest peripheral point of any other half meridian.

The contact lens of one or more claims of the example set A, wherein a thickness profile of the substantially rotationally symmetric region of the non-optical peripheral carrier zone in any meridian is within at least 6% of an average thickness profile of the non-optical peripheral carrier zone measured about the optical centre of the contact lens.

The contact lens of one or more claims of the example set A, including a spherical blending zone between the optical zone and the non-optical peripheral carrier zone, wherein the width of the spherical blending zone spans at least 0.1 mm measured on a semi-chord diameter across the optical centre of the contact lens.

The contact lens of one or more claims of the example set A, wherein the substantially toric or astigmatic power distribution has effective astigmatism or toricity of at least +0.75 dioptre cylindrical power.

The contact lens of one or more claims of the example set A, wherein the substantially toric or astigmatic power distribution has effective astigmatism or toricity of at least +1.25 dioptre cylindrical power.

The contact lens of one or more claims of the example set A, wherein the substantially toric or astigmatic power distribution has effective astigmatism or toricity of at least +1.75 dioptre cylindrical power.

The contact lens of one or more claims of the example set A, wherein the substantially toric or astigmatic power distribution has effective astigmatism or toricity of at least +2.25 dioptre cylindrical power.

The contact lens of one or more claims of the example set A, wherein the substantially toric or astigmatic power distribution is combined with a primary spherical aberration of at least +1 D defined over the entire optic zone.

The contact lens of one or more claims of the example set A, wherein the substantially toric or astigmatic power distribution is combined with a primary spherical aberration of at least −1 D defined over the entire optic zone.

The contact lens of one or more claims of the example set A, wherein the shape of the substantial region configured with substantially toric or astigmatic power distribution is provided within a region of the optical zone that is substantially circular or elliptical.

The contact lens of one or more claims of the example set A, wherein the non-optical peripheral carrier zone provides a specific fit that provides a temporally and spatially varying optical stop signal for the wearer's eye to provide a directional signal to substantially control the growth of the eye.

The contact lens of one or more claims of the example set A, wherein the non-optical peripheral carrier zone is configured to allow at least one of: rotation of the contact lens by at least 15 degrees during an hour of wear on the myopic eye; and rotation of the contact lens by 180 degrees at least thrice during 8 hours of wear.

The contact lens of one or more claims of the example set A, wherein the non-optical peripheral carrier zone provides a specific fit to provide a temporally and spatially varying optical stop signal for the wearer's eye, wherein the varying optical signal provides a substantially consistent directional stimulus or direction cues to inhibit or slow eye growth over time.

The contact lens of one or more claims of the example set A, wherein the contact lens is configured for a myopic eye, without astigmatism, or with astigmatism less than 1 dioptre cylinder power.

The contact lens of one or more claims of the example set A, wherein the contact lens is capable of providing the wearer with an adequate visual performance that is comparable to the performance obtained with a properly fitted commercial single vision contact lens.

The contact lens of one or more claims of the example set A, wherein the contact lens is configured with an astigmatic or toric power zone substantially covering the optic zone wherein the radial power profiles are described by standard conic sections, biconic sections, even or odd extended polynomials, or combinations thereof.

The contact lens of one or more claims of the example set A, wherein the contact lens is configured for the eye that is at risk of becoming myopic.

The contact lens of one or more claims of the example set A, wherein the optical zone is configured to provide, at least in part, adequate foveal correction to the eye, and further configured to provide, at least in part, a temporally and spatially varying stop signal to reduce the rate of eye growth.

The contact lens of one or more claims of the example set A, wherein the optical zone is configured to provide, at least in part, adequate foveal correction to the eye, and further configured to provide, at least in part, a temporally and spatially varying stop signal to reduce the rate of eye growth that is substantially consistent over time.

The contact lens of one or more claims of the example set A, wherein the contact lens is capable of modifying the incoming light and utilises the directional cues offered by the induced astigmatism incorporated at least in part by the central optical zone to decelerate the rate of myopia progression.

The contact lens of one or more claims of the example set A, wherein the contact lens offers a temporally and spatially variant stop signal to the wearers by the virtue of on-eye contact lens rotation facilitated at least in part by the rotationally symmetric non-optical peripheral carrier zone.

A method comprising: applying to a myopic eye or prescribing for a myopic eye a contact lens, the contact lens comprising a configuration effective to, for the myopic eye: provide a spherical correction to at least reduce the myopic error of the eye; and introduce astigmatic error to the myopic eye; and rotate on the eye during wear of the contact lens, whereby the astigmatic error is temporally and spatially variable.

The method of the above claim, wherein the contact lens is a contact lens as claimed in any one or more of the above claims of the example set A.

### Example Set “B”—Asymmetric Distribution Defined with Other Power Profile Variations

A contact lens for an eye, the contact lens including an optical zone around an optical centre and a non-optical peripheral carrier zone about the optical zone, wherein the optical zone is configured with an asymmetric power distribution substantially centred about the optical centre, providing at least in part a meridional correction for the eye, and providing at least in part a meridional stop signal for the eye, and wherein the non-optical peripheral carrier zone is configured substantially without a ballast, or otherwise configured to allow rotation of the lens when on the eye, to provide a substantial temporal and spatial variation to the meridional stop signal.

The contact lens of one or more claims of the example set B, wherein an area of the optical zone configured with the substantially asymmetric power distribution substantially about the optical centre, comprises at least 50% of the optical zone and the remainder of the optic zone is configured with spherical correction for the myopic eye.

The contact lens of one or more claims of the example set B, wherein the meridional correction and the meridional stop signal provided by a region of the optical zone configured with the substantially asymmetric distribution that extends across at least 4 mm of a central region of the contact lens.

The contact lens of one or more claims of the example set B, wherein the substantially asymmetric power distribution of the optical zone is configured on an anterior surface of the contact lens.

The contact lens of one or more claims of the example set B, wherein the substantially asymmetric power distribution of the optical zone is configured on a posterior surface of the contact lens.

The contact lens of one or more claims of the example set B, wherein the substantially asymmetric power distribution of the optical zone is configured in part by an anterior surface and in part by a posterior surface of the contact lens.

The contact lens of one or more claims of the example set B, wherein a thickest point within the non-optical peripheral carrier zone across any one meridian is within a maximum variation of 30 μm of the thickest peripheral point of any other meridian

The contact lens of one or more claims of the example set B, wherein a thickness profile of the substantially rotationally symmetric region of the non-optical peripheral carrier zone in any meridian is within 6% of an average thickness profile of the non-optical peripheral carrier zone measured about the optical centre of the contact lens.

The contact lens of one or more claims of the example set B, including a spherical blending zone between the optical zone and the non-optical peripheral carrier zone, wherein the width of the spherical blending zone spans at least 0.1 mm measured on a semi-chord diameter across the optical centre of the contact lens.

The contact lens of one or more claims of the example set B, wherein the difference of minimum to maximum power across the substantially asymmetric power distribution is at least +1.25 dioptres.

The contact lens of one or more claims of the example set B, wherein the substantially asymmetric power distribution is expressed using a power distribution function described by the expression Sphere+Azimuthal component, wherein the Sphere refers to the distance spherical prescription power to correct the eye, the Azimuthal component of the power distribution function is described as Cₐ*cos(mθ), wherein Cₐ is an azimuthal coefficient, m is an integer between 1 and 6, and Theta (θ) is the azimuthal angle of a given point of the optic zone.

The contact lens of one or more claims of the example set B, wherein the substantially asymmetric power distribution is expressed using a power distribution function described by the expression Sphere+(Radial component)*(Azimuthal component), wherein the Sphere refers to the distance spherical prescription power to correct the myopic eye, the Radial component of the power distribution function is described as Cᵣ*ρ, wherein Cᵣ is the coefficient of the expansion and Rho (φ is the normalised radial co-ordinate (ρ₀/μₘₐₓ); the Azimuthal component of the power distribution function is described as Cₐ*cos (mθ), wherein m can be any integer between 1 and 6, and Theta (θ) is the azimuthal angle, wherein Rho (ρ₀) is the radial coordinate at a given point, wherein μmₐₓ is the maximum radial co-ordinate or semi-diameter of the optic zone.

The contact lens of one or more claims of the example set B, wherein the substantially asymmetric power distribution is expressed using a power distribution function that is described at least in part using at least one or more of the terms of the Bessel circular functions of the first kind with a generic expression of (n, m); wherein the at least one or more of the terms of the Bessel Circular function are obtained when n takes values of 1, 2, 3 and m takes values of ±2.

The contact lens of one or more claims of the example set B, wherein the azimuthal power distribution function is in a form of cos² (mθ), wherein m is an integer between 1 and 6 inclusive.

The contact lens of one or more claims of the example set B, wherein the shape of the substantial region configured with substantially asymmetric power distribution is provided within a region of the optical zone that is substantially circular or elliptical.

The contact lens of one or more claims of the example set B, wherein the non-optical peripheral carrier zone provides a specific fit that provides a temporally and spatially varying optical stop signal for the wearer's eye to provide a directional signal to substantially control the growth of the eye.

The contact lens of one or more claims of the example set B, wherein the non-optical peripheral carrier zone is configured to allow at least one of: rotation of the contact lens by at least 15 degrees during an hour of wear on the myopic eye; or rotation of the contact lens by 180 degrees at least thrice during 8 hours of wear.

The contact lens of one or more claims of the example set B, wherein the non-optical peripheral carrier zone provides a specific fit that provides a temporally and spatially varying optical stop signal for the wearer's eye to provide a directional signal to substantially control eye growth of the eye.

The contact lens of one or more claims of the example set B, wherein the non-optical peripheral carrier zone provides a specific fit providing a temporally and spatially varying optical stop signal for the wearer's eye, to provide a directional signal to substantially control eye growth of the eye that is substantially consistent over time.

The contact lens of one or more claims of the example set B, wherein the contact lens is configured for a myopic eye, without astigmatism, or with astigmatism less than 1 dioptre cylinder power.

The contact lens of one or more claims of the example set B, wherein the contact lens is capable of providing the wearer with an adequate visual performance that is comparable to the performance obtained with a commercial single vision contact lens.

The contact lens of one or more claims of the example set B, wherein the contact lens is configured with an astigmatic or toric power profile substantially across the optic zone described by Bessel functions, Jacobi polynomials, Taylor polynomials, Fourier expansion, or combinations thereof.

The contact lens of one or more claims of the example set B, wherein the contact lens is configured for the eye that is at risk of becoming myopic.

The contact lens of one or more claims of the example set B, wherein the optical zone is configured to provide, at least in part, adequate foveal correction to the eye, and further configured to provide, at least in part, a temporally and spatially varying stop signal to reduce the rate of eye growth.

The contact lens of one or more claims of the example set B, wherein the optical zone is configured to provide, at least in part, adequate foveal correction to the eye, and further configured to provide, at least in part, a temporally and spatially varying stop signal to reduce the rate of eye growth, wherein the efficacy of the treatment or management of eye growth is substantially consistent over time.

The contact lens of one or more claims of the example set B, wherein the contact lens is capable of modifying the incoming light and utilises the directional cues offered by the induced asymmetric optical signal incorporated at least in part by the central optical zone to decelerate the rate of myopia progression.

A method comprising: applying to a myopic eye or prescribing for a myopic eye a contact lens, the contact lens comprising a configuration effective to, for the myopic eye: provide a spherical correction to at least reduce the myopic error of the myopic eye; and introduce a stop signal to the myopic eye; and rotate on the eye during wear of the contact lens, whereby the stop signal is temporally and spatially variable.

The method of the above claim, wherein the contact lens is a contact lens as claimed in any one or more of the above claims of the example set B.

1. A contact lens for a myopic eye, the contact lens characterised by a front surface, a back surface, an optical centre, an optical zone around the optical centre, a blending zone, a non-optical peripheral carrier zone; the optical zone including at least a substantial region configured with substantially tonic or astigmatic power distribution, wherein the substantially tonic or astigmatic power distribution is configured substantially about the optical centre, provides at least in part a meridional correction for the myopic eye, and at least in part introduces meridional astigmatism and a conoid of Sturm producing a stop signal for the myopic eye; and wherein the non-optical peripheral carrier zone is configured with a thickness profile that is substantially rotationally symmetric about the optical centre to facilitate a specific fit on the myopic eye.

2. (canceled)

3. The contact lens of claim 1, wherein the area of the substantial region configured with the substantially tonic or astigmatic power distribution comprises at least 60% of the optical zone and the remainder of the optic zone is configured with the spherical correction for the myopic eye.

4. (canceled)

5. (canceled)

6. (canceled)

7. (canceled)

8. (canceled)

9. (canceled)

10. (canceled)

11. The contact lens of claim 1, wherein the substantially toric or astigmatic power distribution substantially across the optic zone has effective astigmatism or toricity of at least +1.25 DC.

12. The contact lens of claim 1, wherein the substantially toric or astigmatic power distribution substantially across the optic zone is expressed using a power distribution function described by the expression Sphere+(Cylinder/2)*(Azimuthal component), wherein the Sphere refers to the distance spherical prescription power to correct the myopic eye, the Cylinder refers to the magnitude of induced astigmatism or toricity, wherein the Azimuthal component of the power distribution function is described as Ca*cos(mθ), wherein Ca is an azimuthal coefficient, m is an integer between 2 and 6, and Theta (θ) is the azimuthal angle of a given point of the optic zone.

13. The contact lens of claim 1, wherein the substantially toric or astigmatic power distribution substantially across the optic zone is expressed using a power distribution function described by the expression Sphere+(Cylinder/2)*(Radial component)*(Azimuthal component), wherein the Sphere refers to the distance spherical prescription power to correct the myopic eye, the Cylinder refzers to the magnitude of induced astigmatism or toricity, the Radial component of the power distribution function is described as Cr*ρ, wherein Cr is the coefficient of the expansion and Rho (φ is the normalised radial co-ordinate (ρ0/μmax); and wherein the Azimuthal component of the power distribution function is described as Ca*cos (mθ), where m can be any integer between 2 and 6, and Theta (θ) is the azimuthal angle, wherein Rho (ρ0) is the radial coordinate at a given point, wherein μmax is the maximum radial co-ordinate or semi-diameter of the optic zone.

14. The contact lens of claim 1, wherein the substantially toric or astigmatic power distribution substantially across the optic zone is expressed using a power distribution function that is described at least in part using at least one or more of the terms of the Bessel circular functions of the first kind with a generic expression of (n, m); wherein the at least one or more of the terms of the Bessel Circular function are obtained when n takes values of 1, 2, 3 and m takes values of ±2.

15. The contact lens of claim 1, wherein the substantially toric or astigmatic power distribution substantially across the optic zone is further expressed at least in part using a power distribution function described by Jacobi polynomials, Taylor polynomials, Fourier series, or combinations thereof.

16. (canceled)

17. The contact lens of claim 1, wherein the specific fit allows substantially free rotation of the contact lens on the myopic eye; wherein the substantially free rotation of the contact lens is gauged as a rotation of the contact lens by 180 degrees at least thrice per 8 hours of lens wear, or at least 15 degrees within 1 hour of lens wear.

18. (canceled)

19. (canceled)

20. The contact lens of claim 1, wherein the introduced meridional astigmatism in conjunction with the specific fit offers a temporally and spatially varying optical stop signal for the wearer's eye to provide a directional signal to substantially control eye growth of the myopic eye; such that the efficacy of the directional signal remains substantially consistent over time, wherein the substantially consistent efficacy over time is at least 18 months.

21. The contact lens of claim 1, wherein the azimuthal power distribution function may take a form of cos² (mθ), wherein m can be an integer between 2 and 6.

22. The contact lens of claim 1, wherein the substantially toric or astigmatic power distribution is combined with a primary spherical aberration of at least +1 D defined over the entire optic zone.

23. The contact lens of claim 1, wherein the substantially toric or astigmatic power distribution is combined with a primary spherical aberration of at least −1 D defined over the entire optic zone.

24. The contact lens of claim 1, wherein the thickness profile of the substantially rotationally symmetric region of the non-optical peripheral carrier zone in any meridian is within 6% difference of the average thickness profile of the non-optical peripheral carrier zone measured about the optical centre of the contact lens.

25. The contact lens of claim 1, wherein a thickest point within the non-optical peripheral carrier zone across any of the meridians is within a maximum variation of 30 μm of the thickest peripheral point of any other meridian.

26. The contact lens of claim 1, wherein a proportion of at least 50% of the conoid of Sturm falls in front of the retina providing the stop signal to decelerate the rate of myopia progression; wherein the depth of the conoid of Sturm is the distance between the sagittal and tangential image planes.

27. The contact lens of claim 1, wherein the depth of the conoid of Sturm is configured to be between about +0.5D to +3 D.

28. The contact lens of claim 1, wherein the depth of the conoid of Sturm is configured to be between about 0.6 mm to 0 mm.

29. The contact lens of claim 1, wherein the contact lens is capable of modifying the incoming light and utilises the directional cues offered by the introduced meridional astigmatism to decelerate the rate of myopia progression.

30. The contact lens of claim 1, wherein the contact lens is capable of providing the wearer with an adequate visual performance that is comparable to the performance obtained with a commercial single vision contact lens.
